(19) United States
(12) Patent Application Publication
(10) Pub. No.: US 2024/0331392 A1
(43) Pub. Date: Oct. 3, 2024

(54) SYSTEMS AND METHODS FOR DETECTING INDIVIDUALS ENGAGED IN ORGANIZED RETAIL THEFT

(71) Applicant: William Holloway Petrey, JR., Frisco, TX (US)

(72) Inventors: William Holloway Petrey, JR., Frisco, TX (US); Steven Mason, Las Vegas, NV (US)

(73) Assignee: William Holloway Petrey, JR., Frisco, TX (US)

(21) Appl. No.: 18/740,809

(22) Filed: Jun. 12, 2024

Related U.S. Application Data
(63) Continuation-in-part of application No. 18/485,030, filed on Oct. 11, 2023.
Application No. 18/485,030 is a continuation-in-part of application No. 17/688,340, filed on Mar. 7, 2022, now Pat. No. 11,915,485.
Application No. 17/688,340 is a continuation of application No. 16/910,949, filed on Jun. 24, 2020, now Pat. No. 11,270,129.
(60) Provisional application No. 62/866,278, filed on Jun. 25, 2019.
(60) Provisional application No. 63/606,300, filed on Dec. 5, 2023.

(51) Int. Cl. G06V 20/54; G06V 20/62; G06V 40/16; G08B 7/06; G08B 25/10

(52) U.S. Cl. CPC G06V 20/54; G06V 20/63; G06V 40/161; G08B 7/06; G06V 20/625; G08B 25/10

(57) ABSTRACT

A method includes retrieving characteristic data, receiving data captured during a first period, and comparing at least one identified characteristic to a list of characteristics. Each characteristic of the list of characteristics includes a weight value. The method also includes identifying, based on the comparison, at least one characteristic of the list of characteristics corresponding to the at least one identified characteristic, and, in response to a weight value of the identified at least one characteristic of the list of characteristics being greater than a threshold, initiating at least one behavior prevention action.

### CROSS-REFERENCES TO RELATED APPLICATIONS

This application claims priority to and is a continuation-in-part of U.S. patent application Ser. No. 18/485,030 (Attorney Docket No. 85299-108) filed Oct. 11, 2023, entitled “System and Method for Correlating Electronic Device Identifiers and Vehicle Information,” which is a continuation-in-part of U.S. patent application Ser. No. 17/688,340 (Attorney Docket No. 85299-106) filed Mar. 7, 2022, entitled “System and Method for Correlating Electronic Device Identifiers and Vehicle Information,” which is a continuation of U.S. patent application Ser. No. 16/910,949 (Attorney Docket No. 85299-101) filed Jun. 24, 2020, now U.S. Pat. No. 11,270,129, entitled “System and Method for Correlating Electronic Device Identifiers and Vehicle Information,” which claims priority to and the benefit of U.S. Provisional Application Ser. No. 62/866,278 (Attorney Docket No. 85299-100) filed Jun. 25, 2019, the entire disclosures of which are hereby incorporated by reference.

This application also claims priority to and is a conversion of U.S. Provisional Application Ser. No. 63/606,300 (Attorney Docket No. 85299-111) filed Dec. 5, 2023, entitled “Systems and Methods for Detecting Individuals Engaged in Organized Retail Theft.”

### TECHNICAL FIELD

This disclosure relates generally to potential crime detection. More specifically, this disclosure relates to systems and methods for detecting individuals engaged in organized retail theft.

### BACKGROUND

Many public and private areas, including airports, business parks, companies, border checkpoints, neighborhoods, etc. employ measures to enhance the safety of the people and property on the area premises. For example, some neighborhoods are gated and visitors to the communities may be forced to check-in with a guard at a security gate prior to being allowed into the neighborhood. Some neighborhoods employ a crime watch group that includes a group of concerned citizens who work together with law enforcement to help keep their neighborhood safe. Such a program may rely on volunteers to patrol the neighborhood to help law enforcement discover and/or thwart suspicious and/or criminal activity.

Similar measures may be employed in retail locations. For example, a retail location, such as a supermarket, may employ one or more security guards to monitor activity at the premises and, attempt, to identify and prevent potential criminal behavior. However, these and other conventional measures lack the ability to correlate certain information that provides for enhanced identification, tracking, and notification of and/or to suspicious vehicles/individuals.

### SUMMARY

In general, the present disclosure provides a system and method for correlating wireless network information.

An aspect of the disclosed embodiments includes a method for detecting recidivistic characteristics. The method may include: retrieving, from at least one data repository, recidivistic characteristic data; receiving data captured during a first period, the data corresponding to a first location; providing, to an artificial intelligence engine configured to use at least one machine learning model configured to generate at least one recidivistic characteristic prediction, the data captured during the first period and the recidivistic characteristic data; receiving, from the artificial intelligence engine, at least one recidivistic characteristic prediction indicating at least one recidivistic characteristic identified in the data captured during the first period and corresponding to at least one aspect of the recidivistic characteristic data; comparing the at least one recidivistic characteristic of the at least one recidivistic characteristic prediction to a list of recidivistic characteristics, wherein each recidivistic characteristic of the list of recidivistic characteristics includes a weight value; identifying, based on the comparison, at least one recidivistic characteristic of the list of recidivistic characteristics corresponding to the at least one recidivistic characteristic of the at least one recidivistic characteristic prediction; and, in response to a weight value of the identified at least one recidivistic characteristic of the list of recidivistic characteristics being greater than a threshold, initiating at least one recidivistic behavior prevention action.

Another aspect of the disclosed embodiments includes a system for detecting recidivistic characteristics. The system includes a processor, and a memory. The memory includes instructions that, when executed by the processor, may cause the processor to: retrieve, from at least one data repository, recidivistic characteristic data; receive data captured during a first period, the data corresponding to a first location; provide, to an artificial intelligence engine configured to use at least one machine learning model configured to generate at least one recidivistic characteristic prediction, the data captured during the first period and the recidivistic characteristic data; receive, from the artificial intelligence engine, at least one recidivistic characteristic prediction indicating at least one recidivistic characteristic identified in the data captured during the first period and corresponding to at least one aspect of the recidivistic characteristic data; compare the at least one recidivistic characteristic of the at least one recidivistic characteristic prediction to a list of recidivistic characteristics, wherein each recidivistic characteristic of the list of recidivistic characteristics includes a weight value; identify, based on the comparison, at least one recidivistic characteristic of the list of recidivistic characteristics corresponding to the at least one recidivistic characteristic of the at least one recidivistic characteristic prediction; and in response to a weight value of the identified at least one recidivistic characteristic of the list of recidivistic characteristics being greater than a threshold, initiate at least one recidivistic behavior prevention action.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

It should be noted that the term “cellular media access control (MAC) address” may refer to a MAC, international mobile subscriber identity (IMSI), mobile station international subscriber directory number (MSISDN), enhanced network selection (ENS), or any other form of unique identifying number.

### BRIEF DESCRIPTIONS OF THE DRAWINGS

For a more complete understanding of this disclosure and its advantages, reference is now made to the following description, taken in conjunction with the accompanying drawings, in which:

FIG. 1A illustrates a high-level component diagram of an illustrative system architecture, according to certain embodiments of this disclosure;

FIG. 1B illustrates an example of trilateration using the system architecture of FIG. 1A, according to certain implementations of the present disclosure;

FIG. 2 illustrates details pertaining to various components of the illustrative system architecture of FIG. 1A, according to certain embodiments of this disclosure;

FIG. 3 illustrates example method for monitoring vehicle traffic, according to certain embodiments of this disclosure;

FIG. 4 illustrates another example method for monitoring vehicle traffic, according to certain embodiments of this disclosure;

FIG. 5 illustrates example use interfaces presented on computing devices during monitoring vehicle traffic, according to certain embodiments of this disclosure;

FIG. 6 illustrates an example computer system according to certain embodiments of this disclosure;

FIG. 7 illustrates a block diagram of a system for predicting a location of an entity;

FIG. 8 illustrates example location data;

FIG. 9 illustrates a diagram depicting the prediction of a next location of an entity from a current location;

FIG. 10 illustrates a diagram for determining locations to avoid;

FIG. 11 is a flow diagram depicting an embodiment of a method for predicting a location of an entity;

FIG. 12 is a flow diagram depicting an embodiment of a method for predicting a next location for an entity from a current location of the entity;

FIG. 13 is a flow diagram depicting an embodiment of a method for determining locations to avoid;

FIG. 14 is a flow diagram depicting an embodiment of a method for detecting individuals engaged in retail theft; and

FIG. 15 is a flow diagram depicting an embodiment of an alternative method for detecting individuals engaged in retail theft.

### DETAILED DESCRIPTION

Improvement is desired in the field of public safety for certain areas (e.g., neighborhood, airport, business park, border checkpoint, city, and/or retail locations, such as stores, strip malls, shopping complexes, super markets, and/or the like). As discussed above, there are various measures that may be conventionally used, such as gated communities, neighborhood crime watch groups, and so forth. However, the conventional measures lack efficiency and accuracy in identifying suspicious vehicles/individuals and reporting of the suspicious vehicles/individuals, among other things. In some instances, the conventional measures may fail to report the suspicious vehicle/individual, altogether. The causes of the inefficient and/or failed reporting may be at least in part attributable to people (e.g., neighbors in a neighborhood) not having access to verified vehicle and/or personal information of an individual. Further, the conventional measures lack the ability to quickly, accurately, and automatically identify the vehicle as a suspicious vehicle, correlate vehicle information (e.g., license plate identifier (ID)), electronic device information (e.g., electronic device identifier (ID)), face information, etc., and/or perform a preventative action based on the identification.

Additionally, or alternatively, such conventional measures may lack efficiency and accuracy in identifying potential recidivistic behavior. For example, at a retail location, a security guard may patrol various areas within or around the retail location watching for suspicious behavior by individuals (e.g., alone or in association with one or more other individuals) and/or for suspicious vehicles. However, similar to the above, the security guard may lack sufficient knowledge of any relevant criminal history of the individuals and/or verified vehicle information. Further, the security guard may not be trained to identify various combinations of behaviors that indicate recidivism and/or the security guard may lack the ability to analyze such combinations to identify potential recidivism.

Take the following example for illustrative purposes. A neighbor may witness an unknown vehicle drive through the neighborhood several times within a given time period during a day. The neighbor may not recognize the license plate ID or driver and may think about reporting the unknown vehicle to law enforcement. Instead, the neighbor may decide to proceed to do another activity. Subsequently, the person may burglarize a house in the neighborhood. Even if the neighbor attempted to lookup the license plate ID, and was able to find out information about an owner of the vehicle, the neighbor may not be able to determine whether the driver of the vehicle is the actual owner, the neighbor may not be able to determine whether the owner or driver is on a crime watch list, and so forth. Further, the neighbor may not be privy to the electronic device identifier of the electronic device the suspicious individual is carrying or that is installed in the vehicle, which may be used to track the whereabouts of the individual/vehicle in a monitored area. Even if a neighbor obtains an electronic device identifier, there currently is no technique for determining personal information associated with the electronic device identifier. To reiterate, conventional techniques for public safety lack the ability to identify a suspicious vehicle/individual and/or to correlate vehicle information, facial information, and/or electronic device identifiers of electronic devices of the driver to make an informed decision quickly, accurately, and automatically.

Aspects of the present disclosure relate to embodiments that overcome the shortcomings described above. The present disclosure relates to a system and method for correlating electronic device identifiers with vehicle information. The system may include one or more license plate detection zones, one or more electronic device detection zones, and/or one or more facial detection zones. The zones may be partially or wholly overlapping and there may be multiple zones established that span a desired area (e.g., a neighborhood, a city block, a public/private parking lot, any street, etc.). The license plate detection zones, the electronic device detection zones, and/or the facial detection zones may include devices that are communicatively coupled to one or more computing systems via a network. The license plate detection zones may include one or more cameras configured to capture images of at least license plates on vehicles that enter the license plate detection zone. The electronic device detection zone may include one or more electronic device identification sensors, such as a WiFi signal detection device or a Bluetooth® signal detection device. The electronic device identification sensors may be configured to detect and store WiFi Machine Access Control (MAC) addresses, Bluetooth MAC addresses, and/or cellular MAC addresses (e.g., International Mobile Subscriber Identity (IMSI), Mobile Station International Subscriber Directory Number (MSISDN), and Electronic Serial Numbers (ESN)) of electronic devices that enter the electronic device detection zone based on the signals emitted by the electronic devices. The facial detection zones may include one or more cameras configured to capture images or digital frames that are used to recognize a face. Any suitable MAC address may be detected, and to that end, a MAC address may be any combination of the IDs described herein (e.g., MAC, MSISIDN, IMSI, ESN, etc.).

The computing system may analyze the images captured by the cameras and detect a license plate identifier (ID) of a vehicle. The license plate ID may be compared with trusted license plate IDs that are stored in a database. When there is not a trusted license plate ID that matches the license plate ID, the computing system may identify the vehicle as a suspicious vehicle. Then, the computing system may correlate the license plate ID of the vehicle with at least one of the stored electronic device identifiers. In some embodiments, the license plate ID and the at least one of the stored electronic device identifiers may be correlated with a face of the individual. In some embodiments, personal information, such as name, address, Bluetooth MAC address, WiFi MAC address, criminal record, whether the suspicious individual is on a crime watch list, etc. may be retrieved using the license plate ID or the at least one of the stored electronic device identifiers that is correlated with the license plate ID of the suspicious vehicle.

The system may include several computer applications that may be accessed by registered users of the system. For example, a client application may be accessed by a computing device of a user, such as a neighbor in a neighborhood implementing the system. The client application may present a user interface including an alert when a suspicious vehicle and/or individual is detected. The user interface may present several preventative actions for the user. For example, the user may contact the suspicious individual using the personal information (e.g., send a threatening text message), notify law enforcement, and so forth. Accordingly, a client application may be accessed by a computing device of a law enforcer. The client application may present a user interface including the notification that a suspicious vehicle and/or individual is detected in the particular zones.

Take the following example of a setup of the system for illustration purposes. In a neighborhood, that may only be accessed by two entrances, license plate detection zones and electronic device detection zones may be placed to cover both lanes at both entrances. In some instances, a facial detection zone may be placed at the entrances with the other zones. Each vehicle may be correlated with each electronic device that enters the neighborhood. Further, the recognized face may be correlated with the electronic device and the vehicle information. The houses inside the neighborhood may setup electronic device detection zones and/or a facial detection zone inside their property to detect electronic device IDs and/or faces and compare them with electronic device IDs and/or faces in a database that stores every correlation that has been made by the system to date (including the most recent correlations of electronic device IDs, faces, and/or vehicles entering the neighborhood). The home owner may be notified via the client application on their computing device if an electronic device and/or face is detected on their property. Further, in some embodiments, the individual associated with the electronic device and/or face may be notified on the electronic device that the homeowner is aware of their presence. If a known criminal with a warrant is detected at either the zones at the entrance or at the zones at the homeowner's property, the appropriate law enforcement agency may be notified of their whereabouts.

The disclosed techniques provide numerous benefits over conventional systems. For example, the system provides efficient, accurate, and automatic identification of suspicious vehicles and/or individuals. Further, the system enables correlating vehicle license plate IDs with electronic device identifiers to enable enhanced detection and/or preventative actions, such as directly communicating with the electronic device of the suspicious individual and/or notifying law enforcement using the client application in real-time or near real-time when the suspicious vehicle enters one or more zones. For example, once the electronic device identifier is detected, a correlation may be obtained with a license plate ID to obtain personal information about the owner that enables contacting the owner directly and/or determining whether the owner is a criminal. The client application provides pertinent information pertaining to both the suspicious vehicle and/or individual in a single user interface without the user having to perform any searches of the license plate ID or electronic device identifier. As such, in some embodiments, the disclosed techniques reduce processing, memory, and/or network resources by reducing searches that the user may perform to find the information. Also, the disclosed techniques provide an enhanced user interface that presents the suspicious vehicle and/or individual information in single location, which may improve a user's experience using the computing device.

In some embodiments, the systems and methods described herein may be configured to detect recidivistic characteristics for at least the purpose of detecting or identifying individuals engaged in organized retail theft and/or other suitable criminal behavior. For example, the systems and methods described herein may be configured to retrieve, from at least one data repository, recidivistic characteristic data. The recidivistic characteristic data may include biometric data (including without limitation mugshot data, fingerprint data, height data, weight data, eye color data, hair color data, any other suitable biometric data, and/or a combination thereof).

Additionally, or alternatively, the recidivistic characteristic data may include recidivism trend data (e.g., retrieved from one or more databases that stores information associated with recidivistic criminal activity, such as geographic and/or temporal information associated with recidivistic criminal activity, crime scene information associated with recidivistic criminal activity, any other suitable information associated with recidivistic criminal activity, or a combination thereof. Additionally, or alternatively, the recidivistic trend data may indicate recidivism trends. Additionally, or alternatively, the recidivistic characteristic data may include recidivism identification data. The recidivism identification data may include data indicating characteristics associated with recidivistic criminal activity, behaviors associated with recidivistic criminal activity, details of recent and/or proximate recidivistic criminal activity, other suitable recidivism identification data, and/or a combination thereof.

The systems and methods described herein may be configured to receive data captured during a first period. The data may correspond to a first location. The first location may include any suitable location, including, but not limited to, a retail location or other suitable location. The data captured during the first period may be captured by a data capturing device at the first location. For example, the data capturing device may include one or more image capturing devices and the data captured during the first period may include at least one set of image data.

Additionally, or alternatively, the data capturing device may include at least one microphone and the data captured during the first period may include at least audio data. Additionally, or alternatively, the data capturing device may include at least one infrared sensor and the data captured during the first period may include infrared data. Additionally, or alternatively, the data capturing device may include at least one automated license plate reader and the data capture during the first period may include image data, and/or any other suitable sensor data. It should be understood that, as used herein, image data may include image stills, video data, metadata, and/or any other suitable image data. The image data may depict one or more individuals of interest or other suitable individuals, one or more vehicles of interest or other suitable vehicles, one or more locations of interest or other suitable locations, and/or other suitable depictured subjects. Additionally, or alternatively, the audio data may include voice data, non-verbal sound data (e.g., including gunshots, explosions, vehicle noise, and/or other suitable non-verbal sound data), and/or the like. In some embodiments, the data capturing device may include any suitable number of sensors or data capturing devices including, instead of, and/or in addition to those described herein.

The systems and methods described herein may be configured to provide, to an artificial intelligence engine configured to use at least one machine learning model configured to generate at least one recidivistic characteristic prediction, the data captured during the first period and the recidivistic characteristic data. The at least one machine learning model may be trained using recidivistic characteristic data obtained from any suitable source, such as one or more public websites, public data repositories, and/or the like. Additionally, or alternatively, when appropriate, the at least one machine learning model may be trained using data retrieved from or provided by private and/or governmental sources subject to the necessary lawful permissions regarding the access to, obtaining of, and/or use of the data.

Additionally, or alternatively, the at least one machine learning model may be subsequently trained using feedback corresponding to the at least one recidivistic characteristic prediction. For example, a user may indicate, using an associated computing device, a satisfaction with the at least one recidivistic characteristic prediction, which may indicate an accuracy or correctness of the at least one recidivistic characteristic prediction. In some embodiments, the machine learning model may identify a plurality of recidivistic characteristics and generate corresponding recidivistic characteristic predictions and/or may indicate the plurality of recidivistic characteristics in the at least one recidivistic characteristic prediction. The at least one recidivistic characteristic indicated by the at least one recidivistic prediction may include one or more words or a combination of words uttered by one or more individuals and indicated by the data captured at the first location. Additionally, or alternatively, the at least one recidivistic characteristic indicated by the at least one recidivistic prediction may include one or more behaviors (e.g., including, but not limited to, hand gestures associated with criminal activity, body movements that may indicate criminal intent, and/or the like), or a combination of behaviors by one or more individuals and indicated by the data captured at the first location. Additionally, or alternatively, the at least one recidivistic characteristic indicated by the at least one recidivistic prediction may include one or more non-verbal sounds (e.g., including, but not limited to, gunshots, explosions, clapping, non-verbal utterances, vehicle door sounds, vehicle trunk sounds, and/or the like), or a combination of non-verbal sounds and indicated by the data captured at the first location. In some embodiments, the at least one recidivistic characteristic indicated by the at least one recidivistic prediction may include any combination of prediction described herein and/or any suitable prediction and/or any suitable combination of any prediction described herein and/or any other suitable prediction.

In some embodiments, the systems and methods described herein may be configured to receive, in addition to or instead of the data captured during the first period and corresponding to the first location, data captured during a second period and corresponding to a second location. The first location may include any suitable location, including, but not limited to, one or more locations within a range of the first location (e.g., including a street or building within a range of the first location). In some embodiments, the second location may be located on a path or route to the first location.

The systems and methods described herein may be configured to provide, to the artificial intelligence engine configured to use the at least one machine learning model configured to generate the at least one recidivistic characteristic prediction, (i) the data captured during the first period and/or the data captured during the second period and (ii) the recidivistic characteristic data.

The systems and methods described herein may be configured to receive, from the artificial intelligence engine, at least one recidivistic characteristic prediction indicating at least one recidivistic characteristic (i) identified in at least one of the data captured during the first period and the data captured during the second period and (ii) corresponding to at least one aspect of the recidivistic characteristic data.

The systems and methods described herein may be configured to compare the at least one recidivistic characteristic of the at least one recidivistic characteristic prediction to a list of recidivistic characteristics. Each recidivistic characteristic of the list of recidivistic characteristics may include a weight value. The weight value may include a numeric or non-numeric value that indicates a significance of the recidivistic characteristic. For example, a recidivistic characteristic that is less likely to indicate recidivistic behavior may include a weight value that is less than a weight value associated with a recidivistic characteristic that is more likely to indicate recidivistic behavior.

The systems and methods described herein may be configured to identify, based on the comparison, at least one recidivistic characteristic of the list of recidivistic characteristics corresponding to the at least one recidivistic characteristic of the at least one recidivistic characteristic prediction.

The systems and methods described herein may be configured to, in response to a weight value of the identified at least one recidivistic characteristic of the list of recidivistic characteristics being greater than a threshold, initiate at least one recidivistic behavior prevention action. The at least one recidivistic behavior prevention action may include contacting local authorities, locking an entrance to the first location, and locking access to one or more portions of the first location (e.g., including one or more safes, one or more partitions or rooms at the first location, and/or the like). In some embodiments, the systems and methods described herein may be configured to generate instructions or commands that initiate the at least one recidivistic prevention action. For example, the systems and methods described herein may be configured to communicate with a controller configured to lock an entrance of the first location. The systems and methods described herein may be configured to generate at least one command and communicate the at least one command to the controller. The at least one command may cause the controller to lock the entrance at the first location. Additionally, or alternatively, the systems and method described herein may be configured to communicate with any suitable controller, machine, processor, robot, network, and/or the like to initiate the at least one recidivistic prevention action.

In some embodiments, the systems and methods described herein may be configured to determine a sum of all weight values of all identified recidivistic characteristics (e.g., corresponding to associated recidivistic characteristics indicated by the at least one recidivistic characteristic prediction). The systems and methods described herein may be configured to determine whether the sum of the weight values is greater than the threshold and, in response to the sum of the weight values being greater than the threshold, initiate the at least one recidivistic behavior prevention action. In some embodiments, the systems and methods described herein may be configured to determine whether the weight value and/or the sum of the weight values is within a range of the threshold and, in response to the weight value and/or the sum of the weight values being within the range of the threshold, initiate the at least one recidivistic prevention action.

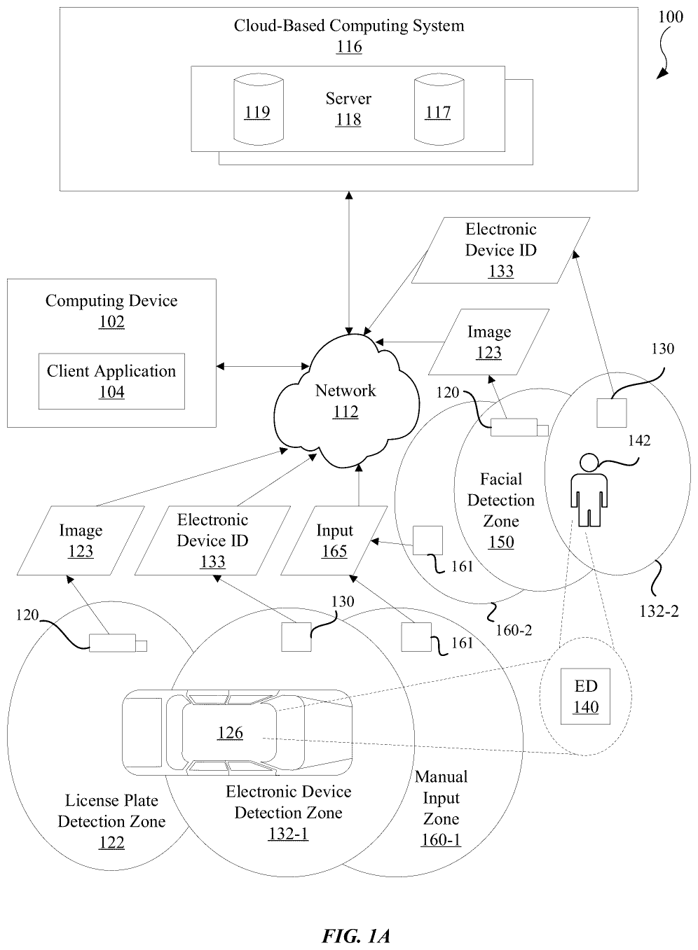

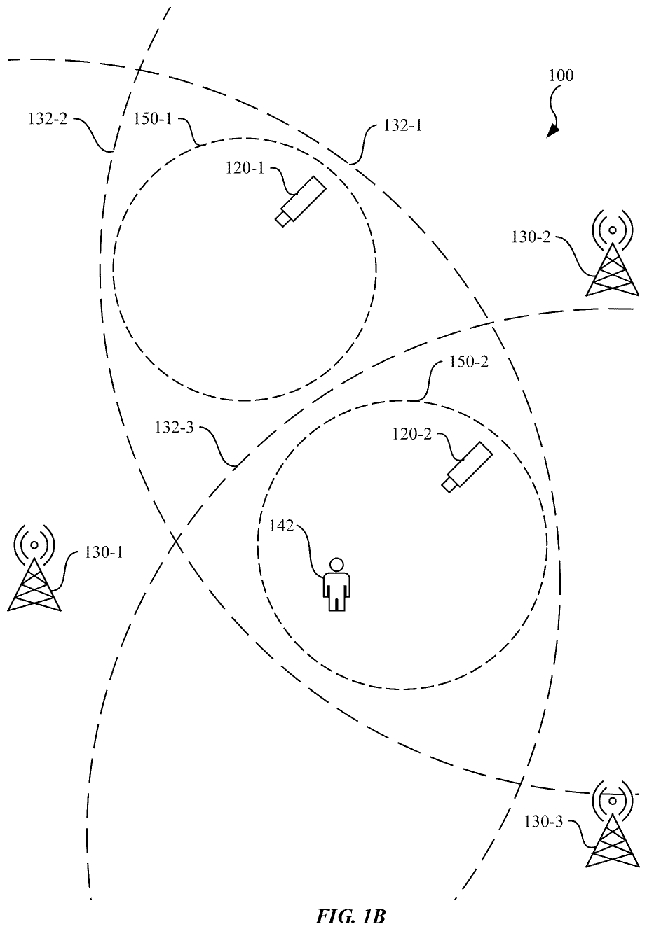

FIGS. 1 through 6, discussed below, and the various embodiments used to describe the principles of this disclosure are by way of illustration only and should not be construed in any way to limit the scope of the disclosure.

FIG. 1A illustrates a high-level component diagram of an illustrative system architecture 100 according to certain embodiments of this disclosure. In some embodiments, the system architecture 100 may include a computing device 102 communicatively coupled to a cloud-based computing system 116, one or more cameras 120, one or more electronic device identification sensors 130, and/or one or more electronic device 140 of a suspicious individual. The cloud-based computing system 116 may include one or more servers 118. Each of the computing device 102, the servers 118, the cameras 120, the electronic device identification sensors 130, and the electronic device 140 may include one or more processing devices, memory devices, and network interface devices.

The network interface devices may enable communication via a wireless protocol for transmitting data over short distances, such as Bluetooth, ZigBee, etc. Additionally, the network interface devices may enable communicating data over long distances, and in one example, the computing device 102 may communicate with a network 112. Network 112 may be a public network (e.g., connected to the Internet via wired (Ethernet) or wireless (WiFi)), a private network (e.g., a local area network (LAN) or wide area network (WAN)), or a combination thereof.

The computing device 102 may be any suitable computing device, such as a laptop, tablet, smartphone, or computer. The computing device may be configured to execute a client application 104 that presents a user interface. The client application 104 may be implemented in computer instructions stored on one or more memory devices and executed by one or more processing devices of the computing device 102. The client application 104 may be a standalone application installed on the computing device 102 or may be an application that is executed by another application (e.g., a website in a web browser).

The computing device 102 may include a display that is capable of presenting the user interface of the client application 104. The user interface may present various screens to a user depending on what type of user is logged into the client application 104. For example, a user, such as a neighbor or person interested in a particular license plate detection zone 122 and/or electronic device detection zone 132, may be presented with a user interface for logging into the system where the user enters credentials (username and password), a user interface that displays alerts of suspicious vehicles and/or individuals in the zones 122 and/or 132 where the user interface includes options for preventative actions, a user interface that presents logged events over time, and so forth. For example, the client application 104 may enable the user to directly contact (e.g., send text message, send email, call) the electronic device 140 of a suspicious individual 142 using personal information obtained about the individual 142. Another user, such as a law enforcer, may be presented with a user interface for logging into the system where the user enters credentials (username and password), a user interface that displays notifications when the user selects to notify law enforcement where the notifications may include information related to the suspicious vehicle and/or individual 142.

In some embodiments, the cameras 120 may be located in the license plate detection zones 122. Although just one camera 120 and one license plate detection zone 122 are depicted, it should be noted that any suitable number of cameras 120 may be located in any suitable number of license plate detection zones 122. For example, multiple license plate detection zones 122 may be used to cover a desired area. A license plate detection zone 122 may refer to an area of coverage that is within the cameras' 120 field of view. The cameras 120 may be any suitable camera and/or video camera capable of capturing a set of images 123 that at least represent license plates of a vehicle 126 that enters the license plate detection zone 122. The set of images 123 may be transmitted by the camera 120 to the cloud-based computing system 116 and/or the computing device 102 via the network 112.

In some embodiments, the electronic device identification sensors 130 may be located in the electronic device detection zones 132. In some embodiments, the license plate detection zone 122 and the electronic device detection zone 132-1 may partially or wholly overlap. The combination of license plate detection zones 122 and the electronic device detection zones 132 may be setup at entrances/exits to certain areas, and/or any other suitable area in a monitored area, to correlate each vehicle information with respective electronic device identifiers 133 of electronic devices 140 being carried in respective vehicles 126. Each of the license plate detection zones 122 and electronic device detection zones 132 may have unique geographic identifiers so the data can be tracked by location. It should be noted that any suitable number of electronic device identification sensors 130 may be located in any suitable number of electronic device detection zones 132. For example, multiple electronic device detection zones 132 may be used to cover a desired area. An electronic device detection zone 132 may refer to an area of coverage that is within the electronic device identification sensor 130 detection area.

In one example, an electronic device detection zone 132-2 and/or a facial detection zone 150 may be setup at a home of a homeowner, such that an electronic device 140 and/or a face of a suspicious individual 142 may be detected and stored when the suspicious individual 142 enters the zone 132-2. The electronic device ID 133 and/or an image of the face may be transmitted to the cloud-based computing device 116 or the computing device 102 via the network 112. In some instances, the suspicious individual 142 may be contacted on their electronic device 140 with a message indicating the homeowner is aware of their presence and to leave the premises. In some instances, if a known criminal individual 142 with a warrant is detected at the combination of zones 122 and 132-1 at an entrance or at the zone 132-2 and 150 at the home, then the proper law enforcement agency may be contacted with the whereabouts of the individual 142.

In some embodiments, the cameras 120 may be located in the facial detection zones 150. Although just one camera 120 and one facial detection zone 150 are depicted, it should be noted that any suitable number of cameras 120 may be located in any suitable number of facial detection zones 122. For example, multiple facial detection zones 150 may be used to cover a desired area. A facial detection zone 150 may refer to an area of coverage that is within the cameras' 120 field of view. The cameras 120 may be any suitable camera and/or video camera capable of capturing a set of images 123 that at least represent faces of an individual 142 that enters the facial detection zone 150. The set of images 123 may be transmitted by the camera 120 to the cloud-based computing system 116 and/or the computing device 102 via the network 112. In some embodiments, the cloud-based computing system 116 and/or the computing device 102 may perform facial recognition by comparing a face detected in the image to a database of faces to find a match and/or perform biometric artificial intelligence that may uniquely identify an individual 142 by analyzing patterns based on the individual's facial textures and shape.

The electronic device identification sensors 130 may be configured to detect a set of electronic device IDs 133 (e.g., Wi-Fi MAC addresses, Bluetooth MAC addresses, and/or cellular MAC addresses) of electronic device 140 within the electronic device detection zone 132. As depicted, the electronic device 140 of a suspicious individual is within the vehicle 126 passing through the electronic device detection zone 132. That is, the electronic device identification sensors 130 may be any suitable Wi-Fi signal detection device capable of detecting Wi-Fi MAC addresses and/or Bluetooth signal detection device capable of detecting Bluetooth MAC addresses of electronic devices 140 that enter the electronic device detection zone 132. The set of images 123 may be transmitted by the camera 120 to the cloud-based computing system 116 and/or the computing device 102 via the network 112. The electronic device identification sensor 130 may store the set of electronic device IDs 133 locally in a memory. The electronic device identification sensor 130 may also transmit the set of electronic device IDs 133 to the cloud-based computing system 116 and/or the computing device 102 via the network 112 for storage.

As noted above, the cloud-based computing system 116 may include the one or more servers 118 that form a distributed computing architecture. Each of the servers 118 may be any suitable computing system and may include one or more processing devices, memory devices, data storage, and/or network interface devices. The servers 118 may be in communication with one another via any suitable communication protocol. The servers 118 may each include the database 117 of trusted vehicle license plate IDs, the personal identification database 119, or both. In some implementations, the database 117 of trusted vehicle license plate IDs and the personal identification database 119 may be stored on the computing device 102.

The database 117 of trusted vehicle license plate IDs may be populated by a processing device adding license plate IDs of vehicles that commonly enter the license plate detection zone 122. In some implementations, the database 117 of trusted vehicle license plate IDs may be populated at least in part by manual entry of license plate IDs associated with vehicles trusted to be within the license plate detection zone 122. For example, the license plate IDs may be added at a manual input zone 160-1 using a computing device 161. These license plate IDs may be associated with vehicles owned by neighbors in a neighborhood, or family members of the neighbors, friends of the neighbors, visitors of the neighbors, contractors hired by the neighbors, any suitable person that is trusted, etc.

The personal identification database 119 may be populated by a processing device adding personal identification information associated with electronic device IDs 133 of electronic devices carried by people that commonly enter the electronic device detection zone 132 (e.g., a list of trusted electronic device IDs). In some embodiments, the personal identification database 119 may be populated at least in part by manual entry of personal identification information associated with electronic device IDs 133 associated with electronic devices 140 trusted to be within the electronic device detection zone 132 (e.g., a list of trusted electronic device IDs). For example, the personal identification information associated with electronic device IDs 133 may be added at the manual input zone 160-1 using the computing device 161. These electronic device IDs 133 may be associated with electronic devices 140 owned by neighbors in a neighborhood, or family members of the neighbors, friends of the neighbors, visitors of the neighbors, contractors hired by the neighbors, etc. Further, in some embodiments, the personal identification database 119 may be populated by entering a list of known suspect individuals from the police department, people entering or exiting border checkpoints, etc.

The personal identification information for untrusted electronic device IDs may also be entered into the personal identification database 119. The personal identification database 119 may also be populated by a processing device adding personal identification information associated with electronic device IDs 133 of electronic devices carried by people that commonly enter the facial detection zone 132 (e.g., face images of trusted individuals). The face images 123 may be manually entered at manual input zone 160-2 using the computing device 161. The personal identification information may include names, addresses, faces, email addresses, phone numbers, electronic device identifiers associated with electronic devices owned by the people (e.g., Bluetooth MAC addresses, Wi-Fi MAC addresses), correlated license plate IDs with the electronic device identifiers, etc. The correlations between the license plate IDs, the electronic device identifiers, and/or the faces may be performed by a processing device using the data obtained from the cameras 120 and the electronic device identification sensors 130. Some of this information may be obtained from public sources, phone books, the Internet, and/or companies that distribute electronic devices. In some embodiments, the personal identification information added to the personal identification database 119 may be associated with people selected based on their residing in or near a certain radius of a geographic region where the zones 122 and/or 132 are set up, based on whether they are on a crime watch list, or the like.

In some implementations, the system 100 uses overlapping detection zones of multiple electronic device identification sensors to narrow the location area of an individual. For example, in FIG. 1B, the three detection zones 132-1, 132-2, and 132-3 of the three electronic device identification sensors 130-1, 130-2, and 130-3 partially overlap with each other. Further, the individual 142 in FIG. 1B is positioned within the overlapping portions of the three detection zones 132-1, 132-2, and 132-3. Thus, when all three electronic device identification sensors 130-1, 130-2, and 130-3 detect an electronic device carried by the individual 142, the system 100 may determine that the individual 142 is located within the overlapping portions of the three detection zones 132-1, 132-2, and 132-3.

In some implementations, the system 100 may further narrow the location area of the individual 142 using trilateration (or multilateration). Each of the three electronic device identification sensors 130-1, 130-2, and 130-3 may determine, based on the signal strength of the electronic device carried by the individual 142, the distance to the individual 142. For example, electronic device identification sensor 130-2 may determine that the electronic device carried by the individual 142 is close to electronic device identification sensor 130-2 when the signal strength is strong or determine that the electronic device is far from electronic device identification sensor 130-2 when the signal strength is weak. Alternatively, or in addition, each of the three electronic device identification sensors 130-1, 130-2, and 130-3 may determine the distance to the individual 142 by measuring the time delay that a signal takes to return to the electronic device identification sensors 130-1, 130-2, and 130-3 from the electronic device carried by the individual 142. For example, electronic device identification sensor 130-3 may determine that the electronic device carried by the individual 142 is close to electronic device identification sensor 130-3 when the time delay is short or determine that the electronic device is far from electronic device identification sensor 130-3 when the time delay is long. “Short” and “long,” as used in the foregoing may refer to any amount of time delay without restriction, so long that the constraint, in any given instance, is that a long time delay be for a greater period of time than a short time delay. The system 100 may, based on the locations of each of the three electronic device identification sensors 130-1, 130-2, and 130-3 and the distances from the electronic device to each of the three electronic device identification sensors 130-1, 130-2, and 130-3, determine the coordinates of the electronic device. For example, the system 100 may determine the coordinates of the electronic device using the follow equations:

$$x = \frac{\begin{matrix}( {r}_{1}^{2} - {r}_{2}^{2} - {x}_{1}^{2} + {x}_{2}^{2} - {y}_{1}^{2} + {y}_{2}^{2} ) ( 2 {y}_{3} - 2 {y}_{3} ) - \\ ( {r}_{2}^{2} - {r}_{3}^{2} - {x}_{2}^{2} + {x}_{3}^{2} - {y}_{2}^{2} + {y}_{3}^{2} ) ( 2 {y}_{2} - 2 {y}_{1} )\end{matrix}}{( 2 {y}_{3} - 2 {y}_{3} ) ( 2 {x}_{2} - 2 {x}_{1} ) - ( 2 {y}_{2} - 2 {y}_{1} ) ( 2 {x}_{3} - 2 {x}_{2} )}$$

$$y = \frac{\begin{matrix}( {r}_{1}^{2} - {r}_{2}^{2} - {x}_{1}^{2} + {x}_{2}^{2} - {y}_{1}^{2} + {y}_{2}^{2} ) ( 2 {x}_{3} - 2 {x}_{2} ) - \\ ( 2 {x}_{2} - 2 {x}_{1} ) ( {r}_{2}^{2} - {r}_{3}^{2} - {x}_{2}^{2} + {x}_{3}^{2} - {y}_{2}^{2} + {y}_{3}^{2} )\end{matrix}}{( 2 {y}_{2} - 2 {y}_{1} ) ( 2 {x}_{3} - 2 {x}_{2} ) - ( 2 {x}_{2} - 2 {x}_{1} ) ( 2 {y}_{3} - 2 {y}_{3} )}$$

wherein:
x, y=coordinates of the electronic device carried by the individual 142;
x₁, y₁=coordinates of electronic device identification sensor 130-1;
r₁=distance between electronic device identification sensor 130-1 and the electronic device;
x₂, y₂=coordinates of electronic device identification sensor 130-2;
r₂=distance between electronic device identification sensor 130-2 and the electronic device;
x₃, y₃=coordinates of electronic device identification sensor 130-3; and
r₃=distance between electronic device identification sensor 130-3 and the electronic device.

Alternatively, or in addition, the system 100 may further narrow the location area of the individual 142 by selecting a different type of detection device located within the overlapping portions of the three detection zones 132-1, 132-2, and 132-3. For example, there are two cameras 120-1 and 120-2 in FIG. 1B with different facial detection zones 150-1 and 150-2. When all three electronic device identification sensors 130-1, 130-2, and 130-3 detect an electronic device carried by the individual 142, the system 100 may select camera 120-2 with facial detection zone 150-2 that is located within the overlapping portions of the three detection zones 132-1, 132-2, and 132-3. The selected camera 120-2 may then detect the location of the individual 142 within facial detection zone 150-2.

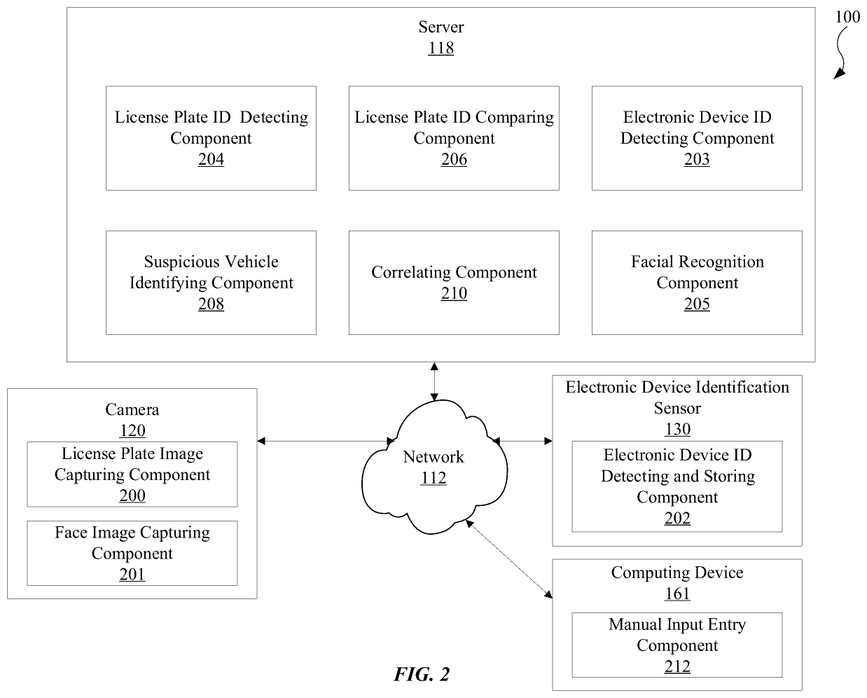

FIG. 2 illustrates details pertaining to various components of the system architecture 100 of FIG. 1A, according to certain embodiments of this disclosure. For example, the camera 120 includes an image capturing component 200 and a face image capturing component 201; the electronic device identification sensor 130 includes an electronic device ID detecting and storing component 202; the server 118 includes an electronic device ID detecting component 203, a license plate ID detecting component 204, a facial recognition component 205, a license plate ID comparing component 206, a suspicious vehicle identifying component 208, and a correlating component 210. In some embodiments, the computing device 161 includes a manual input entry component 212. In some embodiments, the components 203, 204, 205, 206, 208, and 210 may be included in the computing device 102 executing the client application 104. Each of the components 200, 201, 202, 203, 204, 205, 206, 208, 210, and 212 may be implemented in computer instructions stored on one or more memory devices of their respective device and executed by one or more processors of their respective device.

With regards to the image capturing component 200, the component 200 may be configured to capture a set of images 123 within a license plate detection zone 122. At least some of the captured images 123 may represent license plates of a set of vehicles 126 appearing within the field of view of the cameras 120. The image capturing component 200 may configure one or more camera properties (e.g., zoom, focus, etc.) to obtain a clear image of the license plates. The image capturing component 200 may implement various techniques to extract the license plate ID from the images 123, or the image capturing component 200 may transmit the set of images 123, without analyzing the images 123, to the server 118 via the network 112.

With regards to the electronic device ID detecting and storing component 202, the component 202 may be configured to detect and store a set of electronic device IDs 133 of electronic devices located within one or more electronic device detection zones 132. The electronic device ID detecting and storing component 202 may detect a Wi-Fi signal, cellular signal, and/or a Bluetooth signal from the electronic device and be capable of obtaining the Wi-Fi MAC address, cellular MAC address, and/or Bluetooth MAC address of the electronic device from the signal. The electronic device IDs 133 may be stored locally in memory on the electronic device identification sensor 130, and/or transmitted to the server 118 and/or the computing device 102 via the network 112.

With regards to the license plate ID detecting component 204, the component 204 may be configured to detect, using the set of images 123, a license plate ID of a vehicle 126. The license plate ID detecting component 204 may perform optical character recognition (OCR), or any suitable identifier/text extraction technique, on the set of images 123 to detect the license plate IDs.

With regards to the license plate ID comparing component 206, the component 206 may be configured to compare the license plate ID of the vehicle to a database 117 of trusted vehicle license plate IDs. The license plate ID comparing component 206 may compare the license plate ID with each trusted license plate ID in the database 117 of trusted vehicle license plate IDs.

With regards to the suspicious vehicle identifying component 208, the component 208 may identify the vehicle 126 as a suspicious vehicle 126, the identification based at least in part on the comparison of the license plate ID of the vehicle 126 to the database 117 of trusted vehicle license plate IDs. If there is not a trusted license plate ID that matches the license plate ID of the vehicle 126, then the suspicious vehicle identifying component 208 may identify the vehicle as a suspicious vehicle.

With regards to the correlating component 210, the component 210 may be configured to correlate the license plate ID of the vehicle 126 with at least one of the set of stored electronic device IDs 133. Correlating the license plate ID of the vehicle 126 with at least one of the set of stored electronic device IDs 133 may include comparing one or more time stamps of the set of captured images 123 with one or more time stamps of the set of stored electronic device IDs 133. Also, correlating the license plate ID of the vehicle 126 with at least one of the set of stored electronic device IDs 133 may include analyzing at least one of: (i) at least one strength of signal associated with at least one of the set of stored electronic device IDs 133, and (ii) at least one visually estimated distance of at least one vehicle 126 associated with at least one of the set of stored images 123.

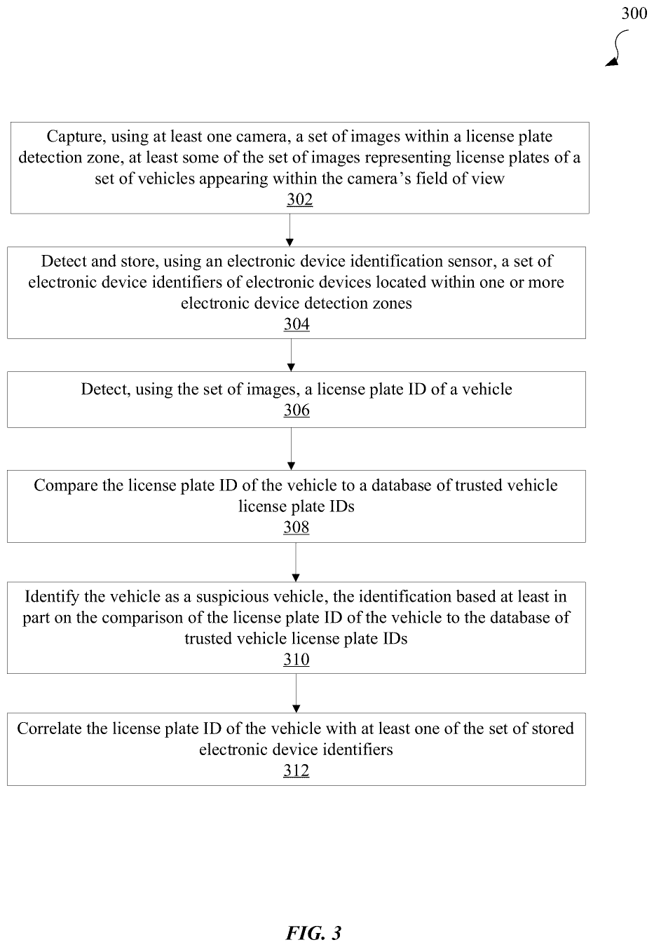

FIG. 3 illustrates an example of a method 300 for monitoring vehicle traffic, according to certain embodiments of this disclosure. The method 300 may be performed by processing logic that may include hardware (circuitry, dedicated logic, etc.), firmware, software, or a combination of both. The method 300 and/or each of their individual functions, subroutines, or operations may be performed by one or more processors of one or more of the devices in FIG. 1A (e.g., computing device 102, cloud-based computing system 116 including servers 118, cameras 120, electronic device identification sensors 130) implementing the method 300. For example, a computing system may refer to the computing device 102 or the cloud-based computing system 116. The method 300 may be implemented as computer instructions that, when executed by a processing device, execute the operations. In certain implementations, the method 300 may be performed by a single processing thread. Alternatively, the method 300 may be performed by two or more processing threads, each thread implementing one or more individual functions, routines, subroutines, or operations of the method 300.

At block 302, a set of images 123 may be captured, using at least one camera 120, within a license plate detection zone 122. At least some of the set of images 123 may represent license plates of a set of vehicles 126 appearing within the camera's field of view. One or more camera properties (e.g., zoomed in, focused, etc.) may be configured to enable the at least one instance of the camera 120 to obtain clear images 123 of the license plates.

At block 304, a set of electronic device identifiers 133 of electronic devices 140 located within one or more electronic device detection zones 132 may be detected and stored using an electronic device identification sensor 130. In some embodiments, the electronic device identification sensor 130 may include at least one of a Wi-Fi signal detection device, cellular signal detection device, or a Bluetooth signal detection device. In some embodiments, the set of electronic device identifiers 133 may include at least one of a Bluetooth MAC address, cellular MAC address, or a Wi-Fi MAC address. In some embodiments, at least one of the set of stored electronic device identifiers 133 may be compared with a list of trusted device identifiers.

At block 306, a license plate ID of a vehicle 126 may be detected using the set of images 123. The images 123 may be filtered, rendered, and/or processed in any suitable manner such that the license plate IDs may be clearly detected using the set of images 123. In some embodiments, object character recognition (OCR) may be used to detect the license plate IDs in the set of images 123. The OCR may electronically convert each image in the set of images 123 of the license plate IDs into computer-encoded license plate IDs that may be stored and/or used for comparison.

In some embodiments, a face of the individual 142 may be detected by a camera 120 in the facial detection zone 150. An image 123 may be captured by the camera 120 and facial recognition may be performed on the image to detect the face of the individual. The detected face and/or the image 123 may be transmitted to the cloud-based computing system 116 and/or the computing device 102.

At block 308, the license plate ID of the vehicle 126 may be compared to a database of trusted vehicle license plate IDs. In some embodiments, the database 117 of trusted vehicle license plate IDs may be populated at least in part by adding license plate IDs of vehicles 126 that commonly enter the license plate detection zone 122 to the database 117 of trusted vehicle license plate IDs. In some embodiments, the database 117 of trusted vehicle license plate IDs may be populated at least in part by manual entry of license plate IDs associated with vehicles 126 trusted to be within the license plate detection zone 122. For example, the trusted vehicles may belong to the neighbors, family members of the neighbors, friends of the neighbors, law enforcement, and so forth.

At block 310, the vehicle may be identified as a suspicious vehicle 126. The identification may be based at least in part on the comparison of the license plate ID of the vehicle to the database 117 of trusted vehicle license plate IDs. For example, if the license plate ID is not matched with a trusted license plate ID stored in the database 117 of trusted vehicle license plate IDs, then the vehicle associated with the license plate ID may be identified as a suspicious vehicle 126.

At block 312, the license plate ID of the vehicle 126 may be correlated with at least one of the set of stored electronic device identifiers 133. In some embodiments, the face of the individual 142 may also be correlated with the license plate ID and the at least one of the set of stored electronic device identifiers 133. In some embodiments, the face of the individual 142 may also be correlated with the license plate ID and the at least one of the set of stored electronic device identifiers 133. In some embodiments, the personal identification database 119 may be accessed. In some embodiments, correlating the license plate ID of the vehicle 126 with at least one of the set of stored electronic device identifiers 133 may include comparing one or more time stamps of the set of captured images 123 with one or more time stamps of the set of stored electronic device identifiers 133. In some embodiments, correlating the license plate ID of the vehicle 126 with the at least one of the set of stored electronic device identifiers 133 may include analyzing at least one of (i) at least one strength of signal associated with at least one of the set of stored electronic device identifiers 133, and (ii) at least one visually estimated distance of at least one vehicle associated with at least one of the set of stored images 123.

Personal identification information of at least one suspicious individual may be retrieved from the at least one personal identification database 119 by correlating information of the personal identification database 119 with the license plate ID of the vehicle 126 or at least one of the set of electronic device identifiers 133 correlated with the license plate ID of the vehicle 126. The personal identification information may also be obtained using a face detected by the camera 120 to obtain the electronic device ID 133 and/or the license plate ID correlated with the face. The personal identification information may include one or more of a name, a phone number, an email address, a residential address, a Bluetooth MAC address, a cellular MAC address, a Wi-Fi MAC address, whether the suspicious individual is on a crime watch list, a criminal record of the suspicious individual, and so forth.

In some embodiments, a user interface may be displayed on one or more computing devices 102 of one or more neighbors when the one or more computing devices are executing the client application 104, and the user interface may present a notification or alert. In some embodiments, the computing device 102 may present a push notification on the display screen and the user may provide user input (e.g., swipe the push notification) to expand the notification on the user interface to a larger portion of the display screen. The alert or notification may indicate that there is a suspicious vehicle 126 identified within the license plate detection zone 122 and/or the electronic device detection zone 132-1 and may provide information pertaining to the vehicle 126 (e.g., make, model, color, license plate ID, etc.) and personal identification information of the suspicious individual (e.g., name, phone number, email address, Bluetooth MAC address, cellular MAC address, Wi-Fi MAC address, whether the individual is on a crime watch list, whether the individual has a criminal record, etc.).

Further, the user interface may present one or more options to perform preventative actions. The preventative actions may include contacting an electronic device 140 of the suspicious individual using the personal identification information. For example, a user may use a computing device 102 to transmit a communication (e.g., at least one text message, phone call, email, or some combination thereof) to the suspicious individual using the retried personal information.

In addition, the preventative actions may also include notifying law enforcement of the suspicious vehicle and/or individual. This preventative action may be available if it is determined that the suspicious individual is on a crime watch list. A suspicious vehicle profile may be created. The suspicious vehicle profile may include the license plate ID of the suspicious vehicle and/or the at least one correlated electronic device identifiers (e.g., Bluetooth MAC address, Wi-Fi MAC address). The user may select the notify law enforcement option on the user interface and the computing device 102 of the user may transmit the suspicious vehicle profile to another computing device 102 of a law enforcement entity that may be logged into the client application 104 using a law enforcement account.

In some embodiments, the preventative action may include activating an alarm upon detection of the suspicious vehicle 126. The alarm may be located in the neighborhood, for example, on a light pole, a tree, a pole, a sign, a mailbox, a fence, or the like. The alarm may be included in the computing device 102 of a user (e.g., a neighbor) using the client application. The alarm may include auditory (e.g., a message about the suspect, a sound, etc.), visual (e.g., flash certain colors of lights), and/or haptic (e.g., vibrations) elements. In some embodiments, the severity of the alarm may change the pattern of auditory, visual, and/or haptic elements based on what kind of crimes the suspicious individual has committed, whether the suspicious vehicle 126 is stolen, whether the suspicious vehicle 126 matches a description of a vehicle involved in an Amber alert, and so forth.

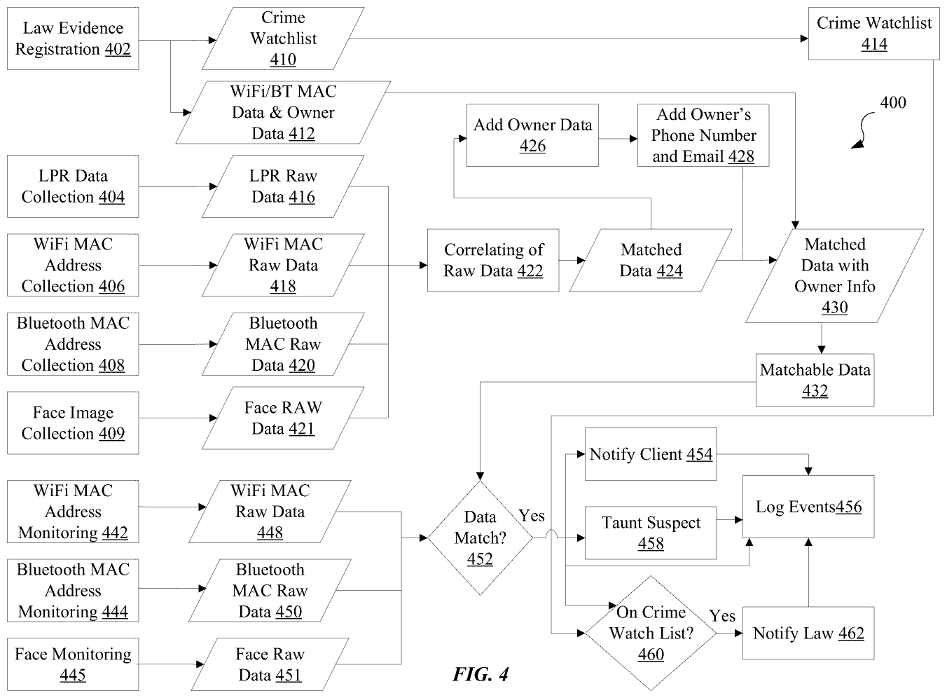

FIG. 4 illustrates another example method 400 for monitoring vehicle traffic, according to certain embodiments of this disclosure. Method 400 includes operations performed by one or more processing devices of one or more devices in FIG. 1A (e.g., computing device 102, cloud-based computing system 116 including servers 118, cameras 120, electronic device identification sensors 130) implementing the method 400. In some embodiments, one or more operations of the method 400 are implemented in computer instructions that, when executed by a processing device, execute the operations of the steps. The method 400 may be performed in the same or a similar manner as described above in regards to method 300.

The method 400 may begin with a setup phase where various steps 402, 404, 406, 408, and/or 409 are performed to register data that may be used to determine whether a vehicle and/or individual is suspicious. For example, at block 402, law evidence may be registered. The law evidence may be obtained from a system of a law enforcement agency. For example, an application programming interface (API) of the law enforcement system may be exposed and API operations may be executed to obtain the law evidence. The law evidence may indicate whether a person is on a crime watch list 410, whether the person has a warrant, whether person has a criminal record, and/or the Wi-Fi/Bluetooth MAC data (address)/cellular data of electronic devices involved in incidents, as well as the owner information 412 of the electronic devices. The crime watch list 410 information may be used to store crime watch list 414 in a database (e.g., personal identification database 119).

At block 404, license plate registration (LPR) data may be collected using the one or more cameras 120 in the license plate detection zones 122 as LPR raw data 416. The LPR raw data 416 may be used to obtain vehicle owner information (e.g., name, address, phone number, email address) and vehicle information (e.g., license plate ID, make, model, color, year, etc.). For example, the LPR raw data 416 may include at least the license plate ID, which may be used to search the Department of Motor Vehicles (DMV) to obtain the vehicle owner information and/or vehicle information. In some instances, the LPR raw data 416 may be collected from manual entry. At block 406, Wi-Fi MAC addresses may be collected from various sources as Wi-Fi MAC raw data 418. For example, the Wi-Fi MAC raw data 418 may be collected from the electronic device identification sensors 130 in the electronic device detection zones 132. In some instances, trusted Wi-Fi MAC addresses may be manually obtained from certain people owning electronic devices in an area covered by the electronic device detection zones 132 and stored in a database (e.g., personal identification database 119). In some embodiments, cellular raw data (e.g., cellular MAC addresses) may be collected from electronic device identification sensors 130. At block 408, Bluetooth MAC addresses may be collected from various sources as raw data 420. For example, the Bluetooth MAC raw data 418 may be collected from the electronic device identification sensors 130 in the electronic device detection zones 132. In some instances, trusted Bluetooth MAC addresses may be manually obtained from certain people owning electronic devices in an area covered by the electronic device detection zones 132 and stored in a database (e.g., personal identification database 119). In some embodiments, the Bluetooth MAC addresses may be collected from the electronic device identification sensors 130 at the electronic device detection zones 132. At block 409, face images may be collected as raw data 421 by the one or more cameras 120 in the facial detection zones 150. Facial recognition may be performed to detect and recognize faces in the face images.

At block 422, the LPR raw data 416, the Wi-Fi MAC raw data 418, the Bluetooth MAC raw data 420, the cellular raw data, and/or the face raw data 421 may be correlated or paired to generate matched data 424. That is, the data from license plate ID detection, LPR systems, personal electronic device detection, and/or facial information may be combined to generate matched data 424 and stored in the database 117 of trusted vehicle license plate IDs and/or the personal identification database 119. In some embodiments, the license plate IDs are compared to the personal identification database 119 of trusted vehicle license plate IDs to determine whether the detected license plate ID is in the database 117 of trusted vehicle license plate IDs. If not, the vehicle 126 may be identified as a suspicious vehicle and the license plate ID of the vehicle may be correlated with at least one of the set of stored electronic device IDs 133. This may result in creation of a database of detected electronic device identifiers 133 correlated with license plate IDs and facial information of individuals. Any unpaired data may be discarded after unsuccessful pairing.

At block 426, owner data of the electronic devices and/or vehicle may be added to the matched data 424. The owner data may include an owner ID, and/or name, address, and the like. Further, at block 428, owner's phone number and email may be added to the matched data. In addition, Wi-Fi/Bluetooth MAC/cellular data and owner data 412 from the law evidence may be included with the matched data 424 and the personal information of the owner to generate matched data with owner information 430. Accordingly, the owner ID may be associated with combined personal information (e.g., name, address, phone number, email, etc.), vehicle information (e.g., license plate ID, make, model, color, year, vehicle owner information, etc.), and electronic device IDs 133 (e.g., Wi-Fi MAC address, Bluetooth MAC adder). At block 432, the matched data with owner information 430 may be further processed (e.g., formatted, edited, etc.) to generate matchable data. This may conclude the setup phase.

Next, the method 400 may include a monitoring phase. During this phase, the method 400 may include blocks 442, 444, and 445. At block 442, Wi-Fi MAC address monitoring may include one or more electronic device identification sensors 130 detecting and storing a set of Wi-Fi MAC addresses as Wi-Fi MAC raw data 448. In some embodiments, cellular signal monitoring may include one or more electronic device identification sensors 130 detecting and storing a set of cellular MAC addresses as cellular raw data. At block 444, Bluetooth MAC address monitoring may include one or more electronic device identification sensors 130 detecting and storing a set of Bluetooth MAC addresses as Bluetooth MAC raw data 450. At block 445, face monitoring may include the one or more cameras 120 capturing face images and recognizing faces in the face images as face raw data 451. The Wi-Fi MAC raw data 448, Bluetooth MAC raw data 450, and/or face raw data 451 may be compared to matchable data 432 at decision block 452.

At block 452, the electronic device IDs 133 and/or faces detected by the electronic device identification sensors 130 and/or the cameras 120 may be compared to the matchable data. The matchable data may include personal identification information that is retrieved from at least the personal identification database 119. That is, the detected electronic device IDs 133 and/or faces may be compared to the database 117 of trusted vehicle license plate IDs and/or the personal identification database 119 to find any correlation of the detected electronic device IDs 133 and/or faces with license plate IDs.

If there is a matching electronic device ID to the detected electronic device ID and/or a matching face to the detected face, and there is a correlation with a license plate ID in the database 117 of trusted vehicle license plate IDs and/or the personal identification database 119, then a suspicious vehicle 126/individual 143 may be detected. At block 456, the detected match event may be logged. At block 454, the user interface of the client application 104 executing on the computing device 102 may present an alert of the suspicious vehicle 126/individual 142. At block 456, the detected notification event may be logged. At block 458, the electronic device 140 of the suspicious individual 142 may be notified that his presence is known (e.g., taunted). At block 456, the taunting event may be logged.

At decision block 460, the crime watch list 414 may be used to determine if the identified individual 142 is on the crime watch list 414 using the individual's personal information. If the individual 142 is on the watch list 414, then at block 462, the appropriate law enforcement agency may be notified. At block 456, the law enforcement agency notification event may be logged.

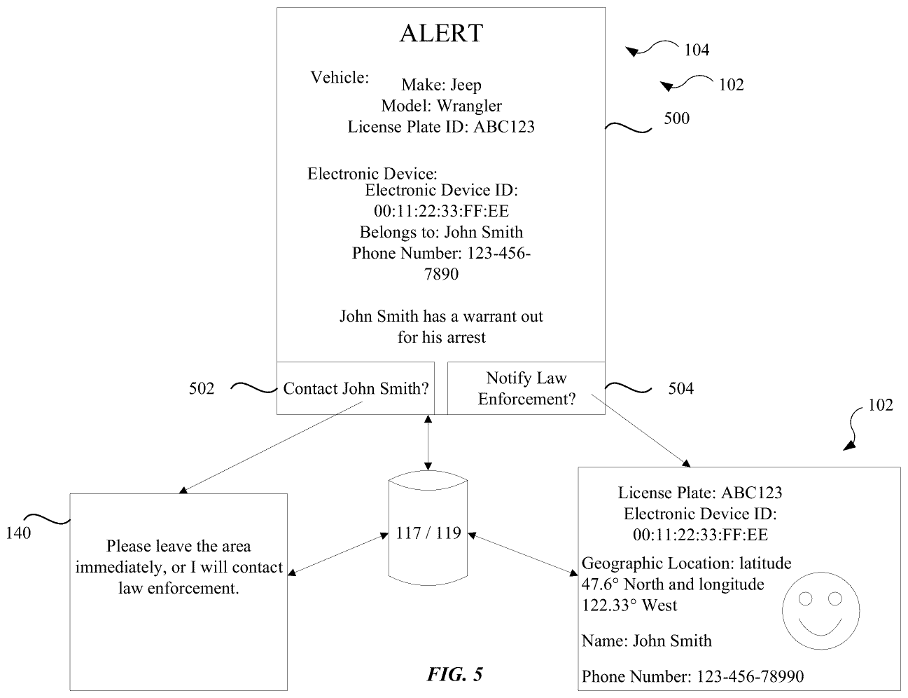

FIG. 5 illustrates example use interfaces presented on computing devices during monitoring vehicle traffic, according to certain embodiments of this disclosure. It should be noted that a user interface 500 may present vehicle information and electronic device information in a single user interface. When a suspicious vehicle 126/individual 142 is detected based on the vehicle license plate ID and/or the electronic device IDs 133, a notification may be presented on the user interface 500 of the client application 104 executing on the computing device 102 of a user (e.g., homeowner, neighbor, interested citizen). As depicted, the notification includes an alert displaying vehicle information and electronic device information. The vehicle information includes the “Make: Jeep”, “Model: Wrangler”, “License Plate ID: ABC123”. The electronic device information includes “Electronic Device ID: 00:11:22:33:FF:EE”, “Belongs to: John Smith”, “Phone Number: 123-456-7890”. Further, the user interface 500 presents that the owner has a warrant out for his arrest. The notification event may be logged in the database 117/119 or any suitable database of the system architecture 100.

The user interface 500 includes various preventative action options represented by user interface element 502 and 504. For example, user interface element 502 may be associated with contacting the detected suspicious individual 142 directly. Upon selection of the user interface element 502, the user may be able to send a text message to the electronic device 140 of the suspicious individual 142. For example, the text message may read “Please leave the area immediately, or I will contact law enforcement.” However, any suitable message may be sent. The message/taunting event may be logged in the database 117/119 or any suitable database of the system architecture 100.

Since the suspicious individual 142 has a warrant out for his arrest and/or is on a crime watch list, the user interface element 504 may be displayed that provides the option to notify law enforcement. Upon selection of the user interface element 504, a notification may be transmitted to a computing device 102 of a law enforcement agency. The notification may include vehicle information (e.g., “License Plate ID: ABC123”), electronic device information (e.g., “Electronic Device ID: 00:11:22:33:FF:EE”), as well as location of the detection (e.g., “Geographic Location: latitude 47.6° North and longitude 122.33° West”), and personal information (“Name: John Smith”, “Phone Number: 123-456-7890”, a face of the individual 142). The law enforcement agency event may be logged in the database 117/119 or any suitable database of the system 100.

Below are example data tables that may be used to implement the system and method for monitoring vehicle traffic disclosed herein. The data tables may include: Client and ID Tables (logID, loginAttempts, clientUser, lawUser, billing), Data Site Info (monitoredSites, dataSites, dataGroups), Raw Collection Data (rawWiFiDataFound, rawBTDataFound, rawLPRDataFound, pairedData), Monitor Data Raw & Matched (monWiFiDataDetected, monBTDataDetected, monWiFiDataMatched, monBTDataMatched), Subject Data (subjectMatch, subjectInfo, subjectLastSeen, criminalWatchList), Notification Logs (subNotifyLog, subNotifyReplyLog, clientNotifyLog).

TABLE 1
loginID
loginID

username
clientID
idType
rights
email
password
lastLogin

Table 1: logID is used for login ID/passwords, authentication and password resets

TABLE 2
loginAttempts
loginAttempts

clientID
username
timeStamp
IP
wifiRSSI
wifiVendor
wifiLocDet
scanInt

Table 2: loginAttempts logs the number of times logins were attempted for both successes and failures

TABLE 3
clientUser
clientUser

clientID
username
firstName
lastName
phone1
phone2
phone3
email1
email2
email3
txt1
txt2
txt3
lastUserName
dataIDs
lawID
monID

Table 3: clientUser includes information for each user.

TABLE 4
lawUser
lawUser

lawUserName
lawID
lawType
lawPrecinct
lawDept
firstName
lastName
phone1
phone2
phone3
email1
email2
email3
txt1
txt2
Txt3
alertType

Table 4: lawUser includes information for law enforcement personnel wanting to be notified of suspicious vehicles 126/individuals 142.

TABLE 5
billing
billing

clientID
username
package
numMons
options
cardType
cardName
cardAddr1
cardAddr2
cardCity
cardState
cardZIP
cardNum
cardExp
cardID

Table 5: billing may be used for third-party billing.

TABLE 6
monitoredSites
monitoredSites

monID
monGroupID
clientID
monAddr1
monAddr2
monCity
monState
monZIP
monCountry

Table 6: monitoredSites includes information for WiFi/Bluetooth monitoring for detection, among other things.

TABLE 7
dataSites
dataSites

dataID
dataAddr1
dataAddr2
dataCity
dataState
dataZIP
dataCountry
groupNum
hwModel
hwSerialNum
softVersion
installDate
devLoc
notes

Table 7: dataSites includes information for WiFi/Bluetooth/License Plate Registration detection sites. These sites may supply data to databases, among other things.

TABLE 8
dataGroups
dataGroups

groupID
groupName
groupLocation
groupAddr1
groupAddr2
groupCity
groupState
groupZIP
groupCountry
info

Table 8: dataGroups may group data groups and monitored sites. Groupings such as Homeowner Associations, neighborhoods, etc.

TABLE 9
rawWiFiDataFound
rawWiFiDataFound

timeStamp
wifiSync
wifiMAC
wifiDevice
wifiRSSI
wifiVendor
wifiLocDet
scanInt

Table 9: raw WiFiDataFound includes raw data dump for WiFi from detection sites used to look for matches.

TABLE 10
rawBTDataFound
rawBTDataFound

timeStamp
btSync
btMAC
btName
btRSSI
btVendor
btCOD
btLocDet
scanInt

Table 10: rawBTDataFound includes raw data dump for Bluetooth from detection sites used to look for matches.

TABLE 11
rawLPRDataFound
rawLPRDataFound

| | |
|---|---|
| timeStamp | lprPic3 |
| lprPlate | lprPic4 |
| lprState | lprPic5 |
| lpreMake | lprPic6 |
| lprModel | lprPic7 |
| lprPlatePic | lprPic8 |
| lprPic1 | lprLocDet |
| lprPic2 | scanInt |

Table 11: rawLPRDataFound may include raw LPR data from detection sites used to look for matches.

TABLE 12
pairedData
pairedData

| | |
|---|---|
| pairedID | btCOD |
| timeStamp | wifiLocDet |
| lprTimeStamp | btLocDet |
| wifiTimeStamp | lprLocDet |
| btTimeStamp | lprPlatePic |
| lprPlate | lprPic1 |
| lprState | lprPic2 |
| lprMake | lprPic3 |
| lprModel | lprPic4 |
| wifiMAC | lprPic5 |
| wifiDevice | lprPic6 |
| wifiVendor | lprPic7 |
| btMAC | lprPic8 |
| btName | subjectID |
| btVendor | |

Table 12: pairedData includes matched data that may be the correlation between vehicle information (e.g., license plate IDs) and electronic device IDs 133.

TABLE 13
monWiFiDataDetected
monWiFiDataDetected

timestamp
wifiSync
wifiMAC
wifiDevice
wifiRSSI
wifiVendor
wifiMonLoc

Table 13: monWiFiDataDetected logs of any MAC address data detected before matching for WiFi.

TABLE 14
monBTDataDetected
monBTDataDetected

timestamp
btSync
btMAC
btName
btRSSI
btVendor
btCOD

Table 14: monBTDataDetected logs of any MAC address data detected before matching for Bluetooth.

TABLE 15
monWiFiDataMatched
monWiFiDataMatched

pairedID
timestamp
wifiSync
wifiMAC
wifiDevice
wifiRSSI
wifiVendor
wifiMonLoc

Table 15: monWiFiDataMatched logs of any matches monitored sites find on the database for WiFi.

TABLE 16
monBTDataMatched
monBTDataMatched

pairedID
timestamp
btSync
btMAC
btName
btRSSI
btVendor
btCOD
btMonLoc

Table 16: monBTDataMatched logs of any matches monitored sites find on the database for Bluetooth.

TABLE 17
subjectMatch
subjectMatch

subjectID
subjectWiFiMAC
subjectBtMAC
timeStamp

Table 17: subjectMatch includes a number of times subject detected in monitored sites and data sites.

TABLE 18
subjectInfo
subjectInfo

| | |
|---|---|
| subjectID | subPhone1 |
| subFirstName | subPhone2 |
| subLastName | subPhone3 |
| subDOB | subPhone4 |
| subAddr1 | subPhone5 |
| subAddr2 | subPhone6 |
| subCity | subTxt1 |
| subState | subTxt2 |
| subZIP | subTxt3 |

Table 18: subjectInfo includes information obtained for owner of license vehicle.

TABLE 19
subjectLastSeen
subjectLastSeen

pairedID
timestamp
subjectID
locID
monID

Table 19: subjectLastSeen includes locations where subject was seen with a timestamp.

TABLE 20
criminalWatchList
criminalWatchList

subjectID
crimeType
dateCommitted
notifyIfDetected
status

Table 20: criminalWatchList includes a criminal watch list that is compared to subjects/individuals 142 to determine if they are a criminal and who to notify if found.

TABLE 21
subNotifyLog
subNotifyLog

timestamp
clientID
subjectID
subPhoneTexted
msgSent
msgStatus

Table 21: subNotifyLog includes notifications sent to the subject to discourage crime.

TABLE 22
subNotifyReplyLog
subNotifyReplyLog

timestamp
clientID
subjectID
subPhoneTexted
msgReceived

Table 22: subNotifyReplyLog includes any replies from the subject after notification.

TABLE 23
clientNotifyLog
clientNotifyLog

timestamp
clientID
msgSent
msgStatus
msgType
numSent
emailSent

Table 23: clientNotifyLog includes log of notification attempts to the client (e.g., computing device 102 of a user).

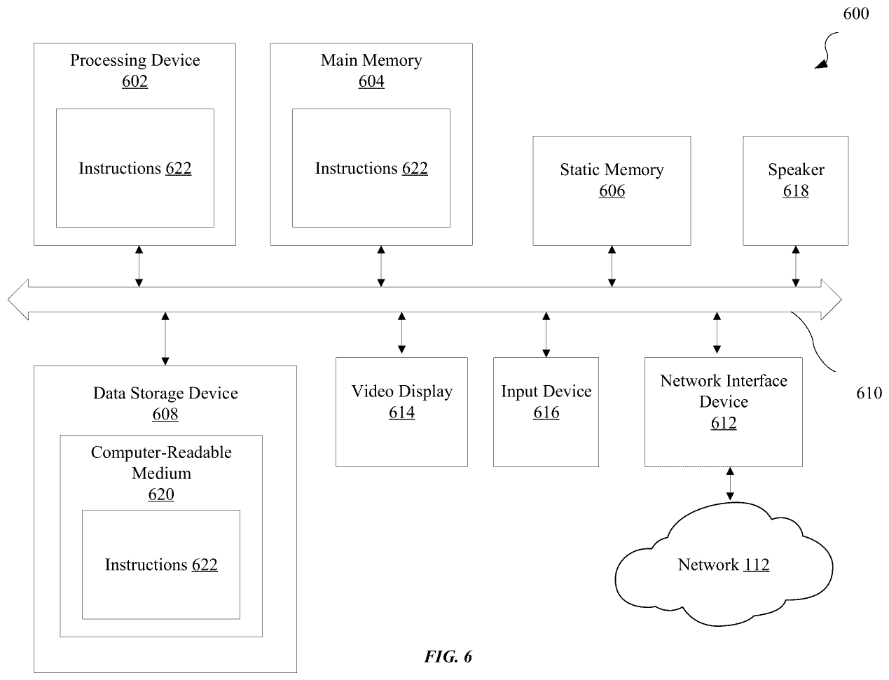

FIG. 6 illustrates example computer system 600 which can perform any one or more of the methods described herein, in accordance with one or more aspects of the present disclosure. In one example, computer system 600 may correspond to the computing device 102, server 118 of the cloud-based computing system 116, the cameras 120, and/or the electronic device identification sensors 130 of FIG. 1A. The computer system 600 may be capable of executing client application 104 of FIG. 1A. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a wearable (e.g., wristband), a set-top box (STB), a personal Digital Assistant (PDA), a mobile phone, a camera, a video camera, an electronic device identification sensor, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 600 includes a processing device 602, a main memory 604 (e.g., read-only memory (ROM), flash memory, dynamic random access memory (DRAM) such as synchronous DRAM (SDRAM)), a static memory 606 (e.g., solid state drive (SSD), flash memory, static random access memory (SRAM)), and a data storage device 608, which communicate with each other via a bus 610.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute instructions for performing any of the operations and steps discussed herein.

The computer system 600 may further include a network interface device 612. The computer system 600 also may include a video display 614 (e.g., a liquid crystal display (LCD) or a cathode ray tube (CRT)), one or more input devices 616 (e.g., a keyboard and/or a mouse), and one or more speakers 618 (e.g., a speaker). In one illustrative example, the video display 614 and the input device(s) 616 may be combined into a single component or device (e.g., an LCD touch screen).

The data storage device 616 may include a computer-readable medium 620 on which the instructions 622 (e.g., implementing control system, user portal, clinical portal, and/or any functions performed by any device and/or component depicted in the FIGURES and described herein) embodying any one or more of the methodologies or functions described herein is stored. The instructions 622 may also reside, completely or at least partially, within the main memory 604 and/or within the processing device 602 during execution thereof by the computer system 600. As such, the main memory 604 and the processing device 602 also constitute computer-readable media. The instructions 622 may further be transmitted or received over a network via the network interface device 612.

While the computer-readable storage medium 620 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The correlation of data, such as vehicle information, electronic device information, face information, and the like may be used beyond the identification of suspicious vehicles. As described below, such information may also be used to predict the location of an entity at a particular time. As used herein, an entity refers to any person(s), animal(s), vehicle(s), or any other suitable object that changes location in time. By predicting the location of an entity at a future time, one or more plans may be developed to allow the entity to avoid an undesirable or dangerous situation.

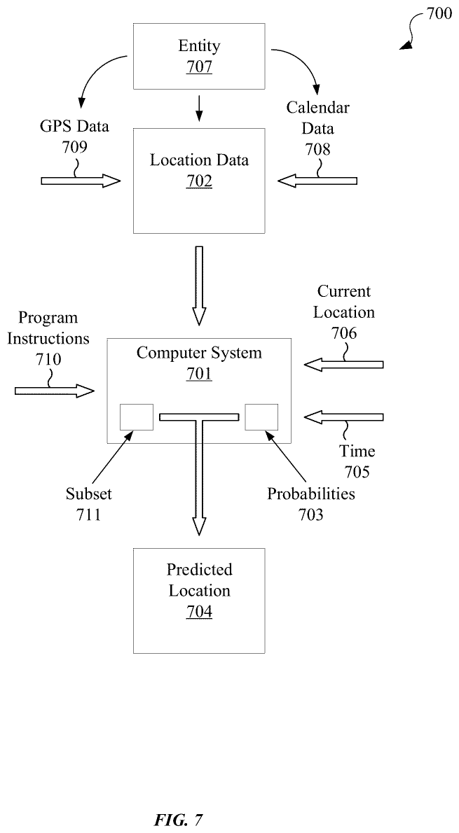

Turning to FIG. 7, a block diagram of a system for predicting a location of an entity is depicted. As illustrated, Computer system 701 is configured to execute program instructions 710 to perform various operations to determine predicted location 704 of entity 707 at time 705. In various embodiments, computer system 701 may be implemented as a server that is configured to relay information to/from user equipment associated with entity 707. In other embodiments, computer system 701 may be implemented as user equipment associated with entity 707, such as a smartphone, or other suitable device.

Computer system 701 is configured to receive location data 702. In various embodiments, to determine location data 702, the location of entity 707 may be tracked over time using GPS data 709, which may be collected from a cellular telephone, a vehicle used by entity 707, detection of entity 707 at various locations using facial recognition, an integrated circuit or chip implanted into entity 707, and the like. Additionally, calendar data 708 from an electronic calendar associated with entity 707 may be used in the generation of location data 702.

Location data 702 may be expressed in terms of a set of location-time pairs (also referred to as “location-time values”) as shown in Equation 1. It is noted that the cardinality of set [symbol] may be any suitable positive integer. In some embodiments, the cardinality of set [symbol] may increase over time as more location-time pairs are added as part of on-going data gathering. In some embodiments, older location-time pairs may be removed from set [symbol] after a threshold time has elapsed or after a particular location has not been visited within a given period of time.

$$𝒮 = \{ ( {l}_{1} , {t}_{1} ) , ( {l}_{2} , {t}_{2} ) , ( {l}_{3} , {t}_{3} ) , … \} . \qquad ( 1 )$$

In various embodiments, locations l₁, l₂, and l₃ may be represented as a collection of at least two coordinates. In some cases, the at least two coordinates may include an x-coordinate and a y-coordinate, together specifying a particular location in a Cartesian location space. Alternatively, the at least two coordinates may include a radius and an angle specifying a particular location from an origin of a location space.

Since corresponding time values of many of the location-time pairs included in [symbol] may not match time 705, computer system 701 is configured to identify, using a range of time values based on time 705, subset 711, which is a subset of set [symbol] .

To generate subset 711, computer system 701 is further configured to compare time values of different location-time pairs in set [symbol] according to Equation 2, where [symbol] ′ is subset 711, tₙ is time 705, and ε is a value that determines a size of the time range. In various embodiments, ε may be selected based on a desired resolution, in time, of the predicted location.

$${𝒮}^{′} = \{ ( {l}_{i} , {t}_{i} ) ∈ 𝒮 \vert {t}_{n} - ε < {t}_{i} < {t}_{n} + ε \} . \qquad ( 2 )$$

Computer system 701 is further configured to determine, using subset 711, respective probabilities 703, that entity 707 will be location in the respective locations specified in subset 711. In various embodiments, computer system 701 may be configured to determine individual ones of respective probabilities 703 using Equation 3, where P(lᵢ) is the probability that entity 707 will be at location lᵢ, | [symbol] ′| is the cardinality of subset 711, and |{(l, t)∈ [symbol] ′|l=lᵢ}| is the number of times lᵢ occurs in the location-time pairs included in subset 711. This can be expressed thusly:

$$P ( {l}_{i} ) = \frac{\vert \{ ( l , t ) ∈ {𝒮}^{′} \vert l = {l}_{i} \} \vert}{\vert {𝒮}^{′} \vert} \qquad ( 3 )$$

Computer system 701 is further configured, using respective probabilities 703, to determine predicted location 704 for entity 707 at time 705. To determine predicted location 704, computer system 701 is further configured to determine a particular location that corresponds to a maximum probability of respective probabilities 703. In various embodiments, computer system 701 may be configured to send predicted location 704 to user equipment, e.g., to a smartphone, associated with entity 707. Alternatively, or additionally, computer system 701 may be configured to send predicted location 704 to one or more other entities which have been specified by entity 707. As described below, computer system 701 may be configured to predict a location for a different entity and determine a plan for avoiding the different entity based on predicted location 704 and the location predicted for the different entity.

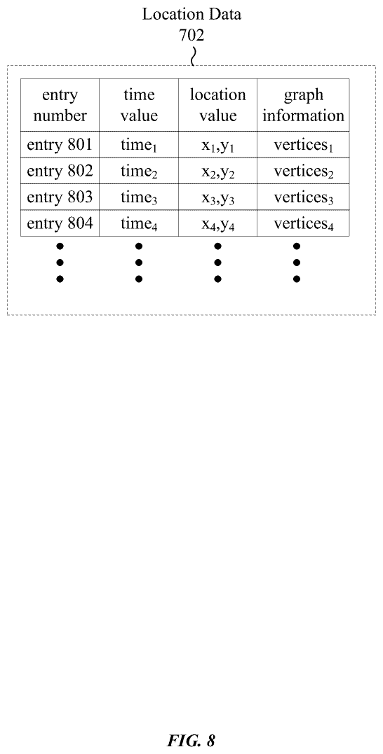

Turning to FIG. 8, a block diagram of an embodiment of location data 702 is depicted. As illustrated, location data 702 includes entries 801-804. Although only four entries are depicted in the embodiment of FIG. 8, in other embodiments, any suitable number of entries may be included in location data 702.

Entries 801-804 have corresponding time values, location values, and optional graph information. For example, entry 801 corresponds to time₁, location x₁, y₁, and vertices₁. In various embodiments, time₁ is indicative of when an entity was located at location x₁, y₁, and is a collection of one or more destination locations from location x₁, y₁.

The time values associated with entries 801-804 may be stored in any suitable format and granularity. For example, the time values associated with entries 801-804 may include information indicative of a date and a time value expressed in hours. In other embodiments, the time value may be expressed in hours, minutes, and seconds, or in any combination and/or portion thereof. Such time values may, in some embodiments, be expressed according to a reference time zone, e.g., Greenwich Mean Time (GMT), or as an offset from such a reference time zone.

As illustrated, the location values associated with entries 801-804 may employ any suitable units. For example, location x₁, y₁ may correspond to latitude and longitude values. Alternatively, location x₁, y₁ may correspond to a number of meters relative to an origin for a given location space. Although the corresponding location values for entries 801-804 are depicted as being xy coordinates, in other embodiments, different coordinate systems may be employed. For example, in some cases, a given location value may be expressed as a radial distance ρ from an origin, and an azimuth angle φ from a reference direction.

In some situations, locations of an entity may be restricted to a particular set of locations, and travel between location in the set of locations may be limited to certain paths. In such cases, the location values associated with entries 801-804 may correspond to the vertices of a directed graph. The connectivity between such vertices is encoded in the graph information. For example, vertices₁ encodes information indicative of possible destination locations from location x₁, y₁. As described below, the graph information can be employed to determine a most likely path from a starting location to a most probable destination location.

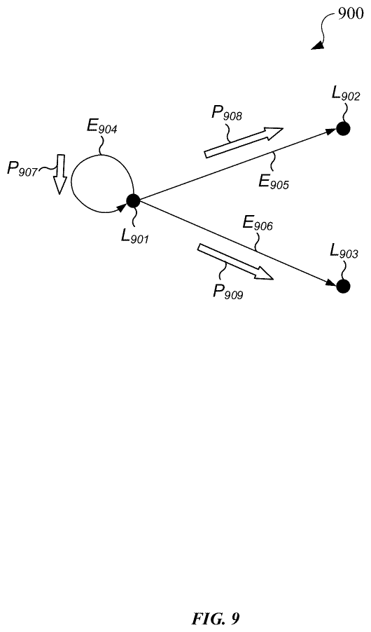

Turning to FIG. 9, a directed graph illustrating the prediction of a next location of an entity from a current location is depicted. As illustrated, directed graph 900 includes locations L₉₀₁, L₉₀₂, and L₉₀₃. Although only three locations (also referred to as “vertices”) are depicted in directed graph 900, in other embodiments, any suitable numbers of vertices and associated edges may be employed.

In the embodiment illustrated in FIG. 9, it is known that an entity is located at L₉₀₁. From L₉₀₁, the entity can remain at L₉₀₁ via edge E₉₀₄. Alternatively, the entity can move from L₉₀₁ to L₉₀₂ via edge E₉₀₅, or move to L₉₀₃ via edge E₉₀₆.

To predict to which of the allowed locations the entity will move, probabilities can be calculated for edges E₉₀₄, E₉₀₅, and E₉₀₆. For example, P₉₀₇ is the probability that the entity will remain at L₉₀₁, while P₉₀₈ is the probability the entity will move from L₉₀₁ to L₉₀₂. In various embodiments, the probability associated with traversing a particular edge, e.g., E₉₀₅, is based on a number of times the particular edge was traversed in a set of allowed destinations from the starting location.

Probabilities P₉₀₇, P₉₀₈, and P₉₀₉ can be calculated according to Equation 4, where [symbol] is a set of allowed locations from L₉₀₁, N is a number of elements of [symbol] , and δ is the Kronecker delta function.

$$P ( l ) = \frac{{\sum }_{i = 1}^{N} δ ( l , {s}_{i} )}{N} , where {s}_{i} ∈ 𝒮 \qquad ( 4 )$$

Once the individual probabilities have been calculated, a prediction of the next location for the entity can be made by selecting which next location has the largest associated probability as shown in Equation (5), where arg max is the “arguments of the maxima” function, which returns a particular value of l for which P(l) is maximum.

$${L}_{n e x t} = arg {max}_{l} P ( l ) , for all l ∈ 𝒮 \qquad ( 5 )$$

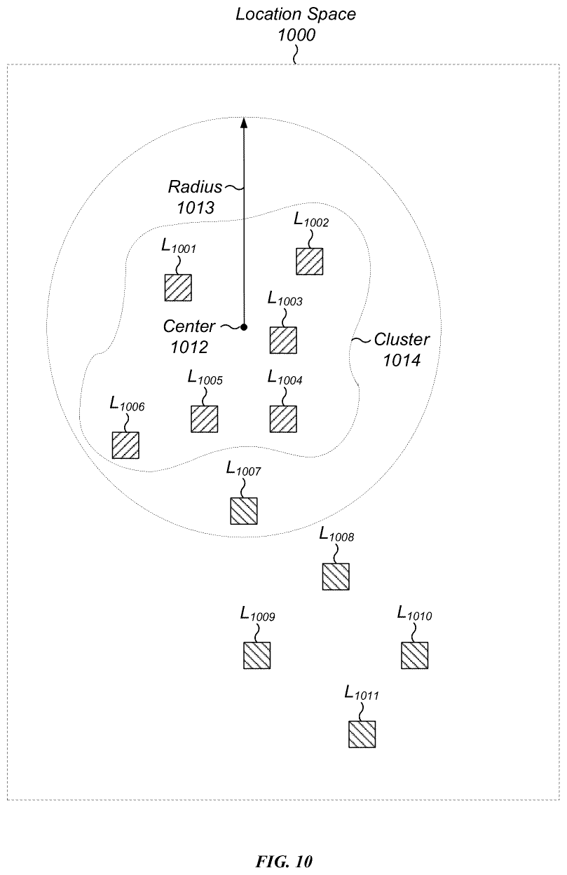

Turning to FIG. 10, a diagram for determining locations to avoid is depicted. As illustrated, location space 1000 includes locations L₁₀₀₁-L₁₀₁₁. In various embodiments, locations L₁₀₀₁-L₁₀₀₆ are possible locations for a first entity at a particular time. Locations L₁₀₀₁-L₁₀₀₆ may be determined using the embodiment of FIG. 7.

L₁₀₀₇-L₁₀₁₁ are locations that the first entity should avoid. In various embodiments, L₁₀₀₇-L₁₀₁₁ may correspond to possible locations of a second entity that the first entry is trying to avoid. In some embodiments, L₁₀₀₇-L₁₀₁₁ may be determined using the embodiment of FIG. 7 or any other suitable technique. In some cases, L₁₀₀₇-L₁₀₁₁ may include real-time location data for the second entity based on tracking the second entity's cellular telephone or, other mobile device, vehicle, and the like.

In some embodiments, L₁₀₀₇-L₁₀₁₁ may correspond to high-traffic areas, road closures, or areas that local police, fire, or emergency services have requested people avoid due to an emergency situation. Alternatively, L₁₀₀₇-L₁₀₁₁ may correspond to locations that a homeland security agency has identified as dangerous due to bomb threats or other threatened or actual acts of terrorism.

Locations L₁₀₀₇-L₁₀₁₁ may, in some cases, be based on weather forecasts. For example, one of locations L₁₀₀₇-L₁₀₁₁ may correspond to a location that is prone to flooding and where, further, rain is forecast in the coming hours.

To determine which, if any, of locations L₁₀₀₇-L₁₀₁₁ should be avoided, a cluster analysis may be performed on results from Equation 3 in order to identify groupings of possible locations that are close to each other. In various embodiments, the cluster analysis may be performed using connectivity-based clustering, centroid-based clustering, distribution-based clustering, density-based clustering, or any other suitable cluster analysis technique.

For the identified clusters, a center of a cluster can be identified by calculating an average x-coordinate and an average y-coordinate, where the calculation uses the coordinates of the predicted locations in the cluster. For example, the x-coordinate of center 1012 of cluster 1014 can be calculated using Equation 6, where xᵢ is the x-coordinate of a given one of locations L₁₀₀₁-L₁₀₀₆, and N is a number of locations in cluster 1014.

$${x}_{c} = {\sum }_{i = 1}^{N} \frac{{x}_{i}}{N} \qquad ( 6 )$$

In a similar fashion, the y-coordinate of center 1012 of cluster 1014 can be calculated using Equation 7, where yᵢ is the y-coordinate of a given one of locations L₁₀₀₁-L₁₀₀₆, and N is a number of locations in cluster 1014.

$${y}_{c} = {\sum }_{i = 1}^{N} \frac{{y}_{i}}{N} \qquad ( 7 )$$

Once the center of a cluster has been identified, a radius from the center can be determined that includes all of the locations within the cluster. For example, radius 1013 can be calculated using Equation 8, where [symbol] ₚ is a set of coordinate pairs for locations L₁₀₀₁-L₁₀₀₆, i.e., [symbol] ₚ={(x₁₀₀₁, y₁₀₀₁), (x₁₀₀₂, y₁₀₀₂), ⋅⋅⋅}

$${R}_{1013} = max \sqrt{{\vert {x}_{i} - {x}_{c} \vert}^{2} + {\vert {y}_{i} - {y}_{c} \vert}^{2}} , ∀ {x}_{i} , {y}_{i} ∈ {𝒮}_{p} \qquad ( 8 )$$

Using the center and radius associated with a cluster, individual ones of locations L₁₀₀₇-L₁₀₁₁ can be checked to see if they fall within the circle defined by the determined center and radius. To perform the check, a distance from a given location to be avoided to the determined center of the circle is calculated. If the calculated distance is less than or equal to the determined radius, the predicted locations that determined the circle should be avoided.

The distance for a given one of locations L₁₀₀₇-L₁₀₁₁ can be calculated using Equation 9, where distᵢ is the distance from center 1012 to a given one of locations L₁₀₀₇-L₁₀₁₁, x_{c} is the x-coordinate of center 1012, and y_{c} is the y-coordinate of center 1012.

$$d i s {t}_{i} = \sqrt{{\vert {x}_{j} - {x}_{c} \vert}^{2} + {\vert {y}_{j} - {y}_{c} \vert}^{2}} \qquad ( 9 )$$

If any of the calculated distances is less than radius 1013, then the first entity should avoid L₁₀₀₁-L₁₀₀₆. For example, as illustrated in FIG. 10, the coordinates of L₁₀₀₇, i.e., x₁₀₀₇ and y₁₀₀₇ result in dist₁₀₀₇ being less than radius 1013, so locations L₁₀₀₁-L₁₀₀₆ should be avoided.

In some embodiments, when a determination is made that a set of predicted locations should be avoided, a message can be sent to the first entity. In some cases, the first entity can inquire for more specific information from an application executing on a server or other computer system. Such a computer system, e.g., computer system 701, may, in response to such an inquiry, provide distances from various ones of L₁₀₀₁-L₁₀₀₆ to a closest one of locations L₁₀₀₇-L₁₀₁₁, allowing the first entity to selectively avoid the locations included in cluster 1014. Alternatively, the computer system may generate an avoidance plan which may include re-scheduling a scheduled event, selecting an alternative transportation method, and the like.

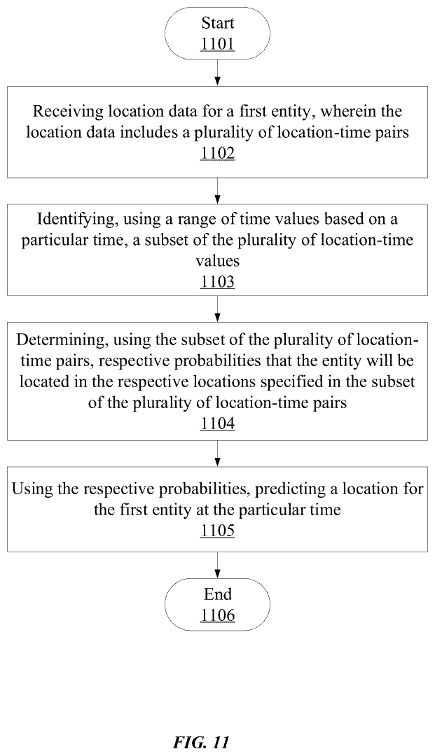

Turning to FIG. 11, a flow diagram depicting an embodiment of a method for predicting a location of an entity is illustrated. The method, which may be applied to various location systems, e.g., system 700 as depicted in FIG. 7, begins in block 1101.

The method includes receiving location data for a first entity (block 1102). In various embodiments, the location data includes a plurality of location-time pairs. In various embodiments, the current location data includes a particular location-time pair. In some cases, the method may include adding to the plurality of location-time pairs, using data received from a mobile communication device associated with the first entity, a new location-time pair. In other embodiments, at least one location-time pair of the plurality of location-time pairs may correspond to an electronic calendar entry associated with the first entity.

The method further includes identifying, using a range of time values based on a particular time, a subset of the plurality of location-time pairs (block 1103). In various embodiments, determining the subset of the plurality of location-time pairs includes determining an upper-time limit and a lower-time limit using the future time, and comparing respective time values of the plurality of location-time pairs to the upper-time limit and the lower-time limit.

The method also includes determining, using the subset of the plurality of location-time pairs, respective probabilities that the entity will be located in the respective locations specified in the subset of the plurality of location-time pairs (block 1104). In some embodiments, determining the respective probabilities includes determining a number of times a given location occurs within the subset of the plurality of location-time pairs, and generating, by a mathematical operation such as by dividing the number of times the given location occurs within the subset of the plurality of location-time pairs by a number of location-time pairs included in the subset, a particular probability of the respective probabilities.

The method further includes, using the respective probabilities, predicting a location for the first entity at the particular time (block 1105). In some cases, predicting the location for the first entity includes determining a largest probability in the respective probabilities.

In some cases, the method may also include, in response to determining a current location for the first entity is available, determining a second subset of the plurality of location-time pairs, where the plurality of location-time pairs corresponds, at a current time, to a plurality of possible destinations from the current location. In various embodiments, the second subset of the plurality of location-time pairs includes a particular location-time pair corresponding to the current location and the current time. In such cases, the method may further include generating a plurality of probabilities that the first entity will be at corresponding destinations of the plurality of possible destinations at a next time subsequent to the current time.

In other cases, the method may also include determining a plan to avoid a second entity based on a predicted location of the second entity and a predicted location of the first entity. The method concludes in block 1106. The embodiment of the method depicted in FIG. 11 may, in various embodiments, be implemented using a computer system that includes one or more processors, such as computer system 701.

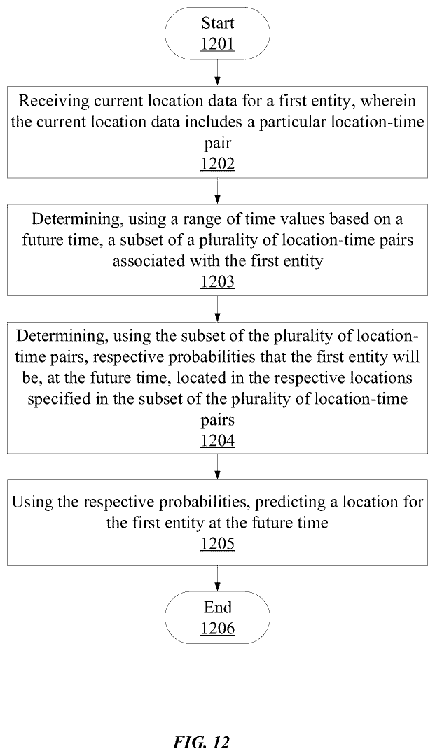

Turning to FIG. 12, a flow diagram depicting an embodiment of a method for predicting a next location for an entity from a current location of the entity is illustrated. In various embodiments, the method may be performed by one or more processors included in a server or a user device. The method, which may be applied to various location systems, e.g., location system 100 as depicted in FIG. 1, begins in block 1201.

The method includes receiving current location data for a first entity (block 1202). In various embodiments, the current location data includes a particular location-time pair. In some cases, the particular location-time pair may be added to a previously received set of location-time pairs.

The method further includes determining, using a range of time values based on a future time, a subset of a plurality of location-time pairs associated with the first entity (block 1203). In various embodiments, determining the subset of the plurality of location-time pairs includes determining, using a threshold value, an upper-time bound and a lower-time bound. The method may further include comparing a time portion of a given location-time pair to the upper-time bound and the lower-time bound.

The method also includes determining, using the subset of the plurality of location-time pairs, respective probabilities that the first entity will be, at the future time, located in the respective locations specified in the subset of the plurality of location-time pairs (block 1204). In various embodiments, determining the respective probabilities includes determining a number of times a given location occurs in the subset of the plurality of location-time pairs, and dividing the number of times the given location occurs in the subset of the plurality of location-time pairs by a total number of location-time pairs included in the subset of the plurality of location-time pairs.

The method further includes, using the respective probabilities, predicting a location for the first entity at the future time (block 1205). The method concludes in block 1206. The embodiment of the method depicted in FIG. 12 may, in various embodiments, be implemented using a computer system, such as computer system 701.

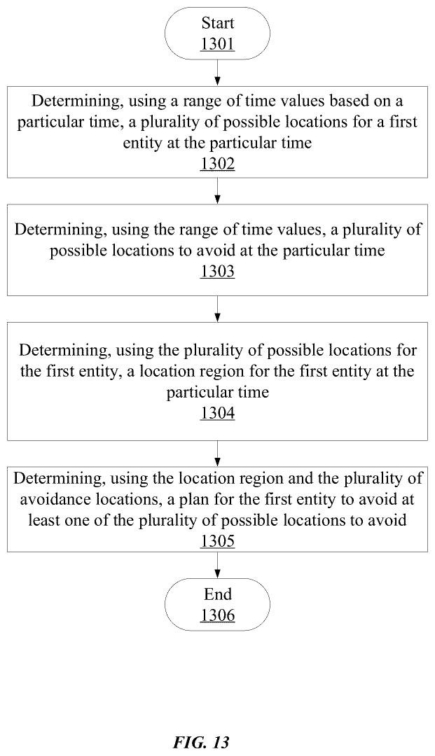

Turning to FIG. 13, a flow diagram depicting an embodiment of a method for determining locations to avoid is illustrated. The method which may be applied to various location systems, e.g., system 700 as depicted in FIG. 7, begins in block 1301.

The method includes determining, using a range of time values based on a particular time, a plurality of possible locations for a first entity at the particular time (block 1302). In various embodiments, determining the plurality of possible locations for the first entity can include performing the at least some of the steps of the methods depicted in the flow diagrams of FIG. 11 and FIG. 12.

The method further includes determining, using the range of time values, a plurality of possible locations to avoid at the particular time (block 1303). In some embodiments, determining the plurality of possible locations to avoid at the particular time can include performing, using location-time pairs associated with an entity to be avoided, at least some of the steps of the methods depicted in the flow diagrams of FIG. 11 and FIG. 12. In some cases, such location-time pairs may include information indicative of areas identified by law enforcement, emergency services, and the like, as being problematic.

The method also includes determining, using the plurality of possible locations for the first entity, a location region for the first entity at the particular time (block 1304). In various embodiments, determining the location region for the first entity includes performing a cluster analysis on the plurality of possible locations for the first entity. The method may further include determining, using a subset of the plurality of possible locations for the first entity generated by the cluster analysis, a center and a radius for a circle.

The method further includes determining, using the location region and the plurality of locations to avoid, a plan for the first entity to avoid at least one of the plurality of possible locations to avoid (block 1305). In some embodiments, determining the plan includes determining respective distances from the center to the plurality of possible locations to avoid and comparing the respective distances to the radius of the circle. The method may also include, in response to determining that a distance from a particular location of the plurality of possible locations to avoid is less than the radius of the circuit, determining the plan.

In various embodiments, the determined plan may include notifying the first entity to avoid all locations included in the location region. In other embodiments, the determined plan may include re-scheduling one or more events scheduled for the first entity. In some embodiments, the determined plan may include sending one or more inquiries to the first entity regarding future plans, and re-predicting the plurality of possible locations based on responses to the one or more inquiries.

The method concludes in block 1306. The method depicted in FIG. 13 may, in various embodiments, be implemented using a computer system, such as computer system 701.

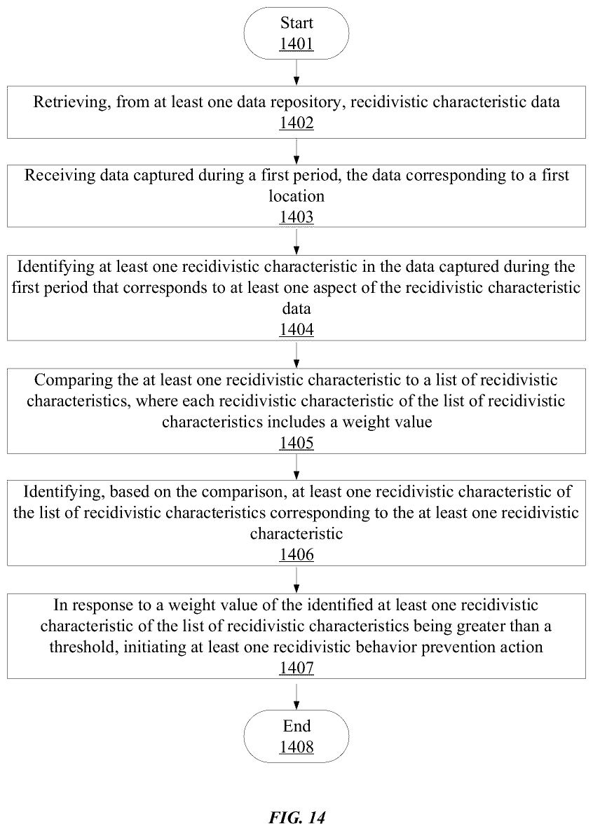

With reference to FIG. 14, a flow diagram depicting an embodiment of a method for detecting individuals engaged in organized retail theft is illustrated. The method which may be applied to various location systems, e.g., system 700 as depicted in FIG. 7, begins in block 1401.

At block 1402, the method retrieves, from at least one data repository, recidivistic characteristic data.

At block 1403, the method receives data captured during a first period, the data corresponding to a first location.

At block 1404, the method identifies at least one recidivistic characteristic in the data captured during the first period. The at least one recidivistic characteristic corresponds to at least one aspect of the recidivistic characteristic data.

At block 1405, the method compares the at least one recidivistic characteristic to a list of recidivistic characteristics. Each recidivistic characteristic of the list of recidivistic characteristics may include a weight value.

At block 1406, the method identifies, based on the comparison, at least one recidivistic characteristic of the list of recidivistic characteristics corresponding to the at least one recidivistic characteristic.

At block 1407, the method, in response to a weight value of the identified at least one recidivistic characteristic of the list of recidivistic characteristics being greater than a threshold, initiates at least one recidivistic behavior prevention action.

At block 1408, the method ends.

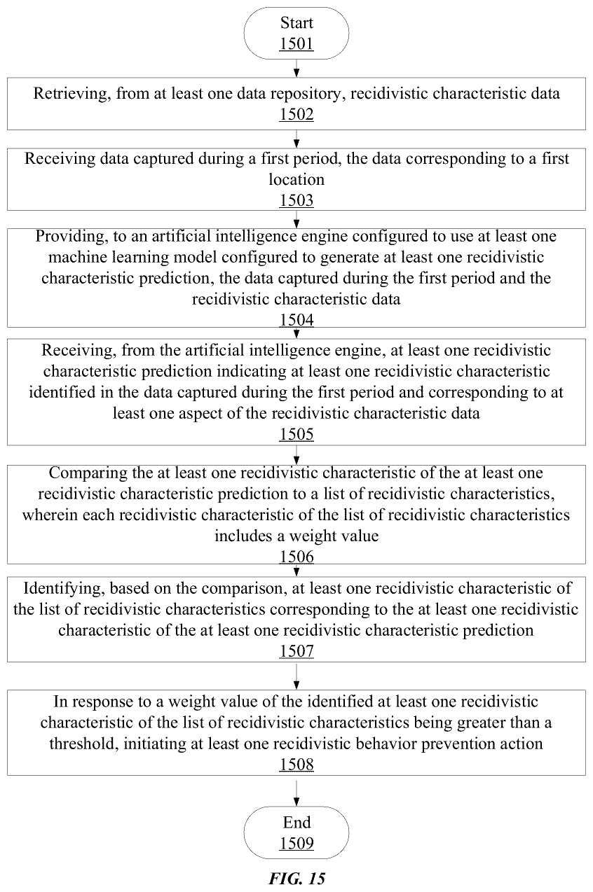

With reference to FIG. 15, a flow diagram depicting an embodiment of an alternative method for detecting individuals engaged in organized retail theft is illustrated. The method, which may be applied to various location systems, e.g., system 700 as depicted in FIG. 7, begins in block 1501.

At block 1502, the method retrieves, from at least one data repository, recidivistic characteristic data.

At block 1503, the method receives data captured during a first period, the data corresponding to a first location.

At block 1504, the method provides, to an artificial intelligence engine configured to use at least one machine learning model configured to generate at least one recidivistic characteristic prediction, the data captured during the first period and the recidivistic characteristic data.

At block 1505, the method receives, from the artificial intelligence engine, the at least one recidivistic characteristic prediction indicating at least one recidivistic characteristic identified in the data captured during the first period and corresponding to at least one aspect of the recidivistic characteristic data.

At block 1506, the method compares the at least one recidivistic characteristic of the at least one recidivistic characteristic prediction to a list of recidivistic characteristics. Each recidivistic characteristic of the list of recidivistic characteristics may include a weight value.

At block 1507, the method identifies, based on the comparison, at least one recidivistic characteristic of the list of recidivistic characteristics corresponding to the at least one recidivistic characteristic of the at least one recidivistic characteristic prediction.

At block 1508, the method, in response to a weight value of the identified at least one recidivistic characteristic of the list of recidivistic characteristics being greater than a threshold, initiates at least one recidivistic behavior prevention action.

At block 1509, the method ends.

In addition to providing notifications as described above, the present disclosure may provide notification of suspicious people in public spaces. For example, the present disclosure may enable the provision of notifications to relevant users and/or authorities, including law enforcement and private security, of criminals in subways. In addition, given the high correlation of people who jump turnstiles in public transportation networks and people with outstanding warrants, the present disclosure may detect people jumping turnstiles and notify law enforcement and/or private security. As a further example, the preset disclosure may provide notifications of intrusion in restricted areas of a hospital.

Consistent with the above disclosure, the examples of systems and method enumerated in the following clauses are specifically contemplated and are intended as a non-limiting set of examples.

Clause 1. A method for detecting recidivistic characteristics, the method comprising: retrieving, from at least one data repository, recidivistic characteristic data; receiving data captured during a first period, the data corresponding to a first location; providing, to an artificial intelligence engine configured to use at least one machine learning model configured to generate at least one recidivistic characteristic prediction, the data captured during the first period and the recidivistic characteristic data; receiving, from the artificial intelligence engine, at least one recidivistic characteristic prediction indicating at least one recidivistic characteristic identified in the data captured during the first period and corresponding to at least one aspect of the recidivistic characteristic data; comparing the at least one recidivistic characteristic of the at least one recidivistic characteristic prediction to a list of recidivistic characteristics, wherein each recidivistic characteristic of the list of recidivistic characteristics includes a weight value; identifying, based on the comparison, at least one recidivistic characteristic of the list of recidivistic characteristics corresponding to the at least one recidivistic characteristic of the at least one recidivistic characteristic prediction; and in response to a weight value of the identified at least one recidivistic characteristic of the list of recidivistic characteristics being greater than a threshold, initiating at least one recidivistic behavior prevention action.

Clause 2. The method of any clause described herein, wherein the at least one recidivistic behavior prevention action comprises contacting local authorities, locking an entrance to the first location, and locking access to one or more portions of the first location.

Clause 3. The method of any clause described herein, wherein the at least one machine learning model is trained using recidivistic characteristic data.

Clause 4. The method of any clause described herein, wherein the at least one machine learning model is subsequently trained using feedback corresponding to the at least one recidivistic characteristic prediction.

Clause 5. The method of any clause described herein, wherein the recidivistic characteristic data includes mugshot data.

Clause 6. The method of any clause described herein, wherein the recidivistic characteristic data includes recidivism trend data.

Clause 7. The method of any clause described herein, wherein the recidivistic characteristic data includes recidivism identification data.

Clause 8. The method of any clause described herein, wherein the data captured during the first period is captured by a data capturing device at the first location.

Clause 9. The method of any clause described herein, wherein the data capturing device includes an image capturing device and the data captured during the first period includes at least one set of image data.

Clause 10. The method of any clause described herein, wherein the data capturing device includes at least one microphone and the data captured during the first period includes audio data.

Clause 11. The method of any clause described herein, wherein the data capturing device includes at least one infrared sensor and the data captured during the first period includes infrared data.

Clause 12. A system for detecting recidivistic characteristics, the system comprising: a processor; and a memory including instructions that, when executed by the processor, cause the processor to: retrieve, from at least one data repository, recidivistic characteristic data; receive data captured during a first period, the data corresponding to a first location; provide, to an artificial intelligence engine configured to use at least one machine learning model configured to generate at least one recidivistic characteristic prediction, the data captured during the first period and the recidivistic characteristic data; receive, from the artificial intelligence engine, at least one recidivistic characteristic prediction indicating at least one recidivistic characteristic identified in the data captured during the first period and corresponding to at least one aspect of the recidivistic characteristic data; compare the at least one recidivistic characteristic of the at least one recidivistic characteristic prediction to a list of recidivistic characteristics, wherein each recidivistic characteristic of the list of recidivistic characteristics includes a weight value; identify, based on the comparison, at least one recidivistic characteristic of the list of recidivistic characteristics corresponding to the at least one recidivistic characteristic of the at least one recidivistic characteristic prediction; and in response to a weight value of the identified at least one recidivistic characteristic of the list of recidivistic characteristics being greater than a threshold, initiate at least one recidivistic behavior prevention action.

Clause 13. The system of any clause described herein, wherein the at least one recidivistic behavior prevention action comprises contacting local authorities, locking an entrance to the first location, and locking access to one or more portions of the first location.

Clause 14. The system of any clause described herein, wherein the at least one machine learning model is trained using recidivistic characteristic data.

Clause 15. The system of any clause described herein, wherein the at least one machine learning model is subsequently trained using feedback corresponding to the at least one recidivistic characteristic prediction.

Clause 16. The system of any clause described herein, wherein the recidivistic characteristic data includes mugshot data.

Clause 17. The system of any clause described herein, wherein the recidivistic characteristic data includes recidivism trend data.

Clause 18. The system of any clause described herein, wherein the recidivistic characteristic data includes recidivism identification data.

Clause 19. The system of any clause described herein, wherein the data captured during the first period is captured by a data capturing device at the first location.

Clause 20. A tangible non-transitory computer-readable medium having program instructions stored therein that, in response to execution by a computer system, causes the computer system to perform operations including: retrieving, from at least one data repository, recidivistic characteristic data; receiving data captured during a first period, the data corresponding to a first location; providing, to an artificial intelligence engine configured to use at least one machine learning model configured to generate at least one recidivistic characteristic prediction, the data captured during the first period and the recidivistic characteristic data; receiving, from the artificial intelligence engine, at least one recidivistic characteristic prediction indicating at least one recidivistic characteristic identified in the data captured during the first period and corresponding to at least one aspect of the recidivistic characteristic data; comparing the at least one recidivistic characteristic of the at least one recidivistic characteristic prediction to a list of recidivistic characteristics, wherein each recidivistic characteristic of the list of recidivistic characteristics includes a weight value; identifying, based on the comparison, at least one recidivistic characteristic of the list of recidivistic characteristics corresponding to the at least one recidivistic characteristic of the at least one recidivistic characteristic prediction; and in response to a weight value of the identified at least one recidivistic characteristic of the list of recidivistic characteristics being greater than a threshold, initiating at least one recidivistic behavior prevention action.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle.

What is claimed is:

1. A method for detecting recidivistic characteristics, the method comprising:
retrieving, from at least one data repository, recidivistic characteristic data;
receiving data captured during a first period, the data corresponding to a first location;
providing, to an artificial intelligence engine configured to use at least one machine learning model configured to generate at least one recidivistic characteristic prediction, the data captured during the first period and the recidivistic characteristic data;
receiving, from the artificial intelligence engine, at least one recidivistic characteristic prediction indicating at least one recidivistic characteristic identified in the data captured during the first period and corresponding to at least one aspect of the recidivistic characteristic data;
comparing the at least one recidivistic characteristic of the at least one recidivistic characteristic prediction to a list of recidivistic characteristics, wherein each recidivistic characteristic of the list of recidivistic characteristics includes a weight value;
identifying, based on the comparison, at least one recidivistic characteristic of the list of recidivistic characteristics corresponding to the at least one recidivistic characteristic of the at least one recidivistic characteristic prediction; and
in response to a weight value of the identified at least one recidivistic characteristic of the list of recidivistic characteristics being greater than a threshold, initiating at least one recidivistic behavior prevention action.

2. The method of claim 1, wherein the at least one recidivistic behavior prevention action comprises contacting local authorities, locking an entrance to the first location, and locking access to one or more portions of the first location.

3. The method of claim 1, wherein the at least one machine learning model is trained using recidivistic characteristic data.

4. The method of claim 3, wherein the at least one machine learning model is subsequently trained using feedback corresponding to the at least one recidivistic characteristic prediction.

5. The method of claim 1, wherein the recidivistic characteristic data includes mugshot data.

6. The method of claim 1, wherein the recidivistic characteristic data includes recidivism trend data.

7. The method of claim 1, wherein the recidivistic characteristic data includes recidivism identification data.

8. The method of claim 1, wherein the data captured during the first period is captured by a data capturing device at the first location.

9. The method of claim 8, wherein the data capturing device includes an image capturing device and the data captured during the first period includes at least one set of image data.

10. The method of claim 8, wherein the data capturing device includes at least one microphone and the data captured during the first period includes audio data.

11. The method of claim 8, wherein the data capturing device includes at least one infrared sensor and the data captured during the first period includes infrared data.

12. A system for detecting recidivistic characteristics, the system comprising:
a processor; and
a memory including instructions that, when executed by the processor, cause the processor to:
retrieve, from at least one data repository, recidivistic characteristic data;
receive data captured during a first period, the data corresponding to a first location;
provide, to an artificial intelligence engine configured to use at least one machine learning model configured to generate at least one recidivistic characteristic prediction, the data captured during the first period and the recidivistic characteristic data;
receive, from the artificial intelligence engine, at least one recidivistic characteristic prediction indicating at least one recidivistic characteristic identified in the data captured during the first period and corresponding to at least one aspect of the recidivistic characteristic data;
compare the at least one recidivistic characteristic of the at least one recidivistic characteristic prediction to a list of recidivistic characteristics, wherein each recidivistic characteristic of the list of recidivistic characteristics includes a weight value;
identify, based on the comparison, at least one recidivistic characteristic of the list of recidivistic characteristics corresponding to the at least one recidivistic characteristic of the at least one recidivistic characteristic prediction; and
in response to a weight value of the identified at least one recidivistic characteristic of the list of recidivistic characteristics being greater than a threshold, initiate at least one recidivistic behavior prevention action.

13. The system of claim 12, wherein the at least one recidivistic behavior prevention action comprises contacting local authorities, locking an entrance to the first location, and locking access to one or more portions of the first location.

14. The system of claim 12, wherein the at least one machine learning model is trained using recidivistic characteristic data.

15. The system of claim 14, wherein the at least one machine learning model is subsequently trained using feedback corresponding to the at least one recidivistic characteristic prediction.

16. The system of claim 12, wherein the recidivistic characteristic data includes mugshot data.

17. The system of claim 12, wherein the recidivistic characteristic data includes recidivism trend data.

18. The system of claim 12, wherein the recidivistic characteristic data includes recidivism identification data.

19. The system of claim 12, wherein the data captured during the first period is captured by a data capturing device at the first location.

20. A tangible non-transitory computer-readable medium having program instructions stored therein that, in response to execution by a computer system, causes the computer system to perform operations including:
retrieving, from at least one data repository, recidivistic characteristic data;
receiving data captured during a first period, the data corresponding to a first location;
providing, to an artificial intelligence engine configured to use at least one machine learning model configured to generate at least one recidivistic characteristic prediction, the data captured during the first period and the recidivistic characteristic data;
receiving, from the artificial intelligence engine, at least one recidivistic characteristic prediction indicating at least one recidivistic characteristic identified in the data captured during the first period and corresponding to at least one aspect of the recidivistic characteristic data;
comparing the at least one recidivistic characteristic of the at least one recidivistic characteristic prediction to a list of recidivistic characteristics, wherein each recidivistic characteristic of the list of recidivistic characteristics includes a weight value;
identifying, based on the comparison, at least one recidivistic characteristic of the list of recidivistic characteristics corresponding to the at least one recidivistic characteristic of the at least one recidivistic characteristic prediction; and
in response to a weight value of the identified at least one recidivistic characteristic of the list of recidivistic characteristics being greater than a threshold, initiating at least one recidivistic behavior prevention action.
